(19) United States
(12) Patent Application Publication
(10) Pub. No.: US 2014/0193077 A1
(43) Pub. Date: Jul. 10, 2014

(54) IMAGE RETRIEVAL APPARATUS, IMAGE RETRIEVAL METHOD, QUERY IMAGE PROVIDING APPARATUS, QUERY IMAGE PROVIDING METHOD, AND PROGRAM

(71) Applicant: CANON KABUSHIKI KAISHA, Tokyo (JP)

(72) Inventors: Hirotaka Shiiyama, Yokohama-shi (JP); Masahiro Matsushita, Yokohama-shi (JP)

(73) Assignee: CANON KABUSHIKI KAISHA, Tokyo (JP)

(21) Appl. No.: 14/148,300

(22) Filed: Jan. 6, 2014

(30) Foreign Application Priority Data
Jan. 8, 2013 (JP) 2013-001080
Jan. 8, 2013 (JP) 2013-001086

(51) Int. Cl. G06F 17/30

(52) U.S. Cl. CPC G06F 17/30244
USPC 382/190

(57) ABSTRACT

An image retrieval apparatus generates an image feature list having a high and/or a low discrimination capability against other images based on the number of stored image features. Based on the image feature list, the image retrieval apparatus selects feature points extracted from a query image.

### BACKGROUND OF THE INVENTION

1. Field of the Invention

The present invention relates to a technique for extracting feature amounts of an image, and more particularly to a technology related to local features to be used in comparing similar images.

2. Description of the Related Art

A method for retrieving similar images by using local feature amounts of images has been discussed. The method includes extracting characteristic points (local feature points) from an image (see C. Harris and M. J. Stephens, “A combined corner and edge detector,” in Alvey Vision Conference, pages 147-152, 1988). A technique for calculating feature amounts (local feature amounts) corresponding to the local feature points based on image information about the local feature points and their periphery has also been known (see David G. Lowe, “Distinctive Image Features from Scale-Invariant Keypoints,” International Journal of Computer Vision, 60, 2 (2004), pp. 91-110). The image retrieval is performed by matching of the local feature amounts.

According to the technique using local feature amounts, local feature amounts are defined as information including a plurality of elements invariant as to rotation and scaling. This enables a retrieval even if images are rotated and/or scaled up or down. Local feature amounts are typically expressed by vectors. Note that local feature amounts are only theoretically invariant as to rotation and scaling. In actual digital images, image rotation and scaling processing can cause calculation errors, which produce slight variations between the local feature amounts before the processing and the corresponding local feature amounts after the processing.

To extract local feature amounts invariant to rotation, for example, David G. Lowe, “Distinctive Image Features from Scale-Invariant Keypoints,” International Journal of Computer Vision, 60, 2 (2004), pp. 91-110, discusses calculating a main direction from a pixel pattern in a local area around a local feature point. When calculating a local feature amount, the local area is rotated with reference to the main direction for directional normalization. To calculate local feature amounts invariant as to scaling, images in different scales are generated inside. Then, local feature points are extracted and local feature amounts are calculated from the images in the respective scales. The set of images generated inside with the series of different scales is typically referred to as a scale space.

Japanese Patent Application Laid-Open No. 2011-43969 discusses an image feature point extraction method for extracting feature points from image data. The image feature point extraction method includes varying an image to obtain image data on a plurality of images, and narrowing down feature points to stable ones. Japanese Patent Application No. 2011-237962 discusses evaluating reproducibility of local feature points and describing local feature points in descending order of the reproducibility to control the number of local feature points.

### SUMMARY OF THE INVENTION

The present invention is directed to a technique for obtaining local feature points and local feature amounts that have a high discrimination capability against other images and are significant for a retrieval.

According to an aspect of the present invention, an image retrieval apparatus includes a storage unit configured to store image features extracted from an input image and the image in association with each other, a generation unit configured to generate a frequently appearing image feature list summarizing image features including similar image features stored in the storage unit in number greater than a predetermined number, a selection unit configured to select an image feature to be used as an image feature of a query image input by an input unit, from image features extracted from the query image by an extraction unit, based on the image features included in the frequently appearing image feature list, and a comparison unit configured to compare image features selected to be used as the image feature of the query image with image features of a registration image stored in the storage unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a functional configuration example of an image retrieval apparatus according to a first exemplary embodiment.

FIG. 2 is a flowchart illustrating an example of an image registration processing according to the first exemplary embodiment.

FIG. 3 is a diagram illustrating an example of reduced image generation processing according to the first exemplary embodiment.

FIG. 4 is a diagram illustrating an example of an image feature list according to the first exemplary embodiment.

FIG. 5 is a diagram illustrating a database in which image feature lists and registration images are registered in association with each other according to the first exemplary embodiment.

FIG. 6 is a flowchart illustrating an example of a differential image feature list generation processing according to the first exemplary embodiment.

FIG. 7 is a flowchart illustrating processing for calculating co-occurrence values of feature amounts.

FIG. 8 is a flowchart illustrating an example of an image retrieval processing according to the first exemplary embodiment.

FIG. 9 is a flowchart illustrating a processing flow for adding preferentially differential image feature amounts from a first feature extraction list, to a second feature extraction list.

FIG. 10 is a flowchart illustrating an example of an image feature comparison processing according to the first exemplary embodiment.

FIG. 11 is a block diagram illustrating a functional configuration example of an image retrieval system according to a second exemplary embodiment.

FIG. 12 is a flowchart illustrating an example of an image retrieval processing of the image retrieval system according to the second exemplary embodiment.

FIG. 13 is a flowchart illustrating an example of processing for updating a differential image feature list according to the second exemplary embodiment.

FIG. 14 illustrates an example of a user interface for making an update setting of the differential image feature list according to the second exemplary embodiment.

FIG. 15 illustrates an example of the differential image feature list.

FIG. 16 illustrates an example of image attribute data.

FIG. 17 is a block diagram illustrating a functional configuration example of an image retrieval apparatus according to a third exemplary embodiment.

FIG. 18 is a flowchart illustrating an example of an image registration processing according to the third exemplary embodiment.

FIG. 19 is a diagram illustrating an example of reduced image generation processing according to the third exemplary embodiment.

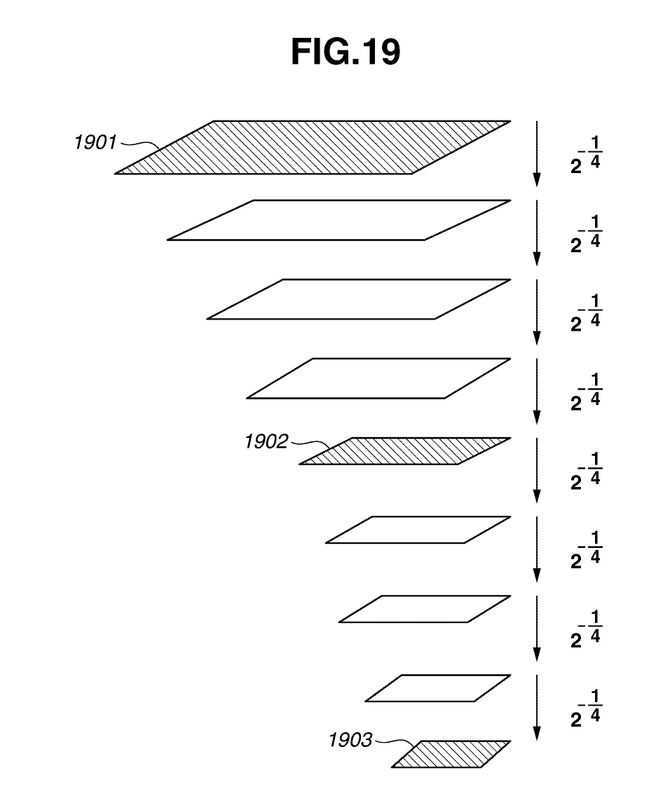

FIG. 20 is a diagram illustrating an example of an image feature list.

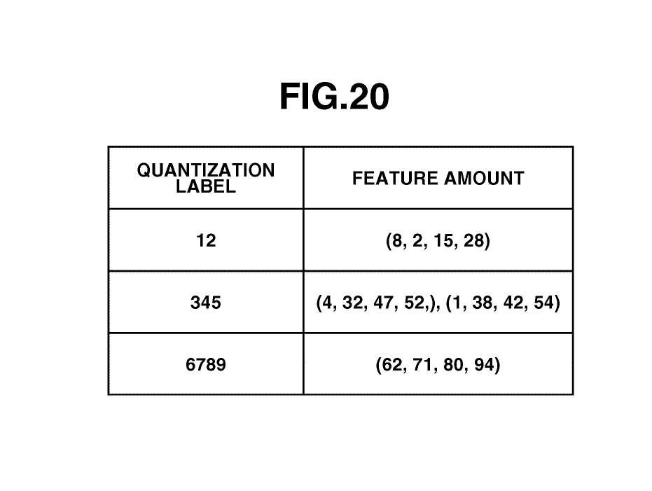

FIG. 21 is a diagram illustrating an example of a database in which image feature lists and registration images are registered in association with each other according to the third exemplary embodiment.

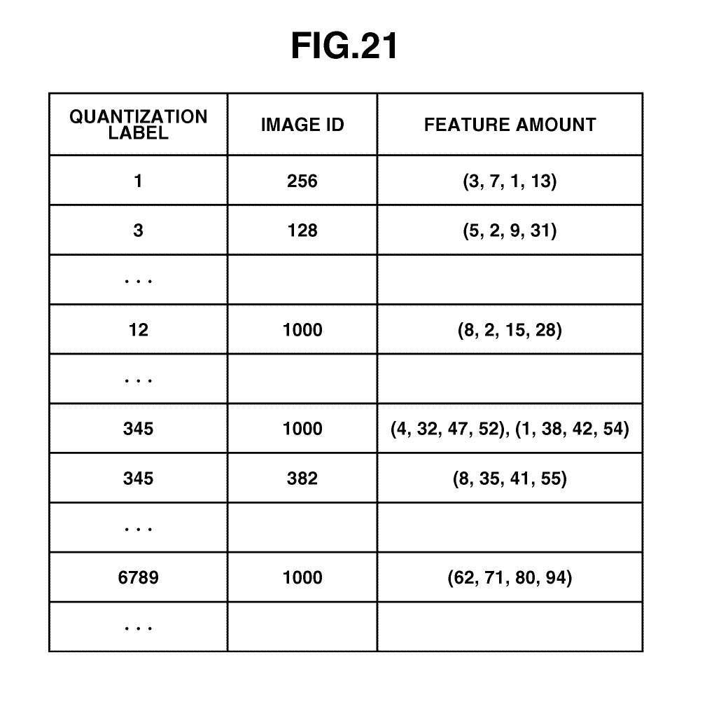

FIG. 22 is a flowchart illustrating an example of a frequently appearing image feature list generation processing according to the third exemplary embodiment.

FIG. 23 is a diagram illustrating an example of a frequently appearing image feature list according to the third exemplary embodiment.

FIG. 24 is a flowchart illustrating an example of an image retrieval processing according to the third exemplary embodiment.

FIG. 25 is a flowchart illustrating an example of a frequently appearing image features reduction processing according to the third exemplary embodiment.

FIG. 26 is a flowchart illustrating an example of image features comparison processing according to the third exemplary embodiment.

FIG. 27 is a block diagram illustrating a functional configuration example of an image retrieval system according to a fourth exemplary embodiment.

FIG. 28 is a flowchart illustrating an example of an image retrieval processing of the image retrieval system according to the fourth exemplary embodiment.

FIG. 29 is a flowchart illustrating an example of frequently appearing image feature list update processing according to the fourth exemplary embodiment.

FIG. 30 illustrates an example of a user interface for making an update setting of the frequently appearing image feature list according to the fourth exemplary embodiment.

FIG. 31 is a block diagram illustrating a functional configuration example of an image retrieval apparatus according to a fifth exemplary embodiment.

FIG. 32 is a flowchart illustrating an example of an image retrieval processing according to the fifth exemplary embodiment.

FIG. 33 is a flowchart illustrating a processing flow for reducing frequently appearing image features other than differential image features in an image feature list according to the fifth exemplary embodiment.

FIG. 34 is a block diagram illustrating a functional configuration example of an image retrieval system according to a sixth exemplary embodiment.

FIG. 35 is a flowchart illustrating an example of an image retrieval processing according to the sixth exemplary embodiment.

### DESCRIPTION OF THE EMBODIMENTS

Various exemplary embodiments, features, and aspects of the invention will be described in detail below with reference to the drawings.

A first exemplary embodiment of the present invention is described below with reference to the drawings. The first exemplary embodiment deals with an image retrieval apparatus that extracts image features from a query image, performs a retrieval by using the resulting image features, and displays a retrieval result.

In an image retrieval using local feature amounts, the image retrieval apparatus extracts a plurality of local feature points from an image and compares local feature amounts calculated from the respective local feature points with each other to perform matching. If a large number of local feature points are extracted from a query image, the number of comparisons between local feature amounts increases, which lowers the retrieval speed. Therefore, it is desirable that the number of local feature points does not become excessively large. It is also desirable that the local feature points includes feature points having scarce features (having a high discrimination capability) unique to the query image.

Portable devices having a photographing function and a communication function are increasing which include mobile phones, smartphones, and digital cameras. As its possible application, a personal computer (PC) or server may perform a retrieval with respect to an image captured by such a portable device as a query, and display the retrieval result on the portable device. One method for achieving this includes calculating local feature amounts in the portable device and transmitting the local feature amounts to the PC or server. If the local feature amounts calculated in the portable device are large, it takes time to transmit the local feature amounts to the PC or server, in which case the time until a retrieval result is displayed may increase. Therefore, it is desirable that the number of local feature points is not excessively large. Depending on the limitations of the portable device, PC or server, and/or communication lines, there may be an upper limit to the size of the local feature amounts.

Under the circumstances, as discussed in Japanese Patent Application Laid-Open No. 2011-43969 and Japanese Patent Application No. 2011-237962, it is conceivable to use not all but some of the extracted local feature points. These methods are intended to narrow local feature points extracted from a query image down to the one which can be stably extracted. For example, a case can be considered where there is a plurality of landmarks that can be photographed from one place, and a retrieval is performed by using one of the landmarks as a query image.

In this case, if local feature amounts are calculated from local feature points commonly and stably extracted from the landmarks, the resulting feature amounts are not useful in distinguishing the landmarks and cannot provide high retrieval accuracy. There is a limit to such closed optimization of feature amounts within a single image. Simply narrowing down feature amounts by using information mainly obtained from a single image does not ensure that the resulting feature amounts have a high discrimination capability for retrieval.

An exemplary embodiment of the present invention has been devised in view of the foregoing problem, and is directed to a technique for obtaining local feature points and local feature amounts that have a high discrimination capability against other images and are significant for a retrieval.

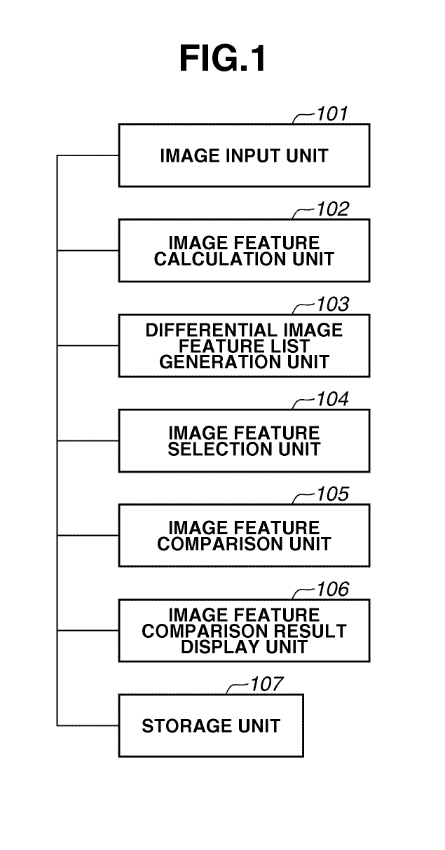

FIG. 1 is a block diagram illustrating a functional configuration example of an image retrieval apparatus according to the present exemplary embodiment. The operation of the components illustrated in FIG. 1 will be described in detail below.

In FIG. 1, an image input unit 101 inputs registration images and a query image. An image feature calculation unit 102 calculates image features of the registration images and the query image input from the image input unit 101.

A differential image feature list generation unit 103 prepares in advance images of an object group that matches attribute information such as global positioning system (GPS)-based position information, time information, and seasons. The differential image feature list generation unit 103 determines co-occurrences between image features of the images object by object. The differential image feature list generation unit 103 employs image features in ascending order of the co-occurrences to generate a differential image feature list having a higher discrimination capability between images corresponding to the same attribute information.

An image feature selection unit 104 refers to image features having the higher discrimination capability in the differential image feature list. The image feature selection unit 104 selects image features from among image features of the query image so that the image features found in the differential image feature list is preferentially used for processing in an image feature comparison unit 105.

The image feature comparison unit 105 compares image features by using the image features of the query image selected by the image feature selection unit 104. An image feature comparison result display unit 106 displays an image feature comparison result of the image feature comparison unit 105. A storage unit 107 is a memory or a hard disk drive (HDD) that stores data in process. The storage unit 107 is also used to store image features.

The foregoing components are comprehensively controlled by a not-illustrated central processing unit (CPU).

The CPU can execute a program or programs to function as various units. An application specific integrated circuit (ASIC) or other control circuits operating in cooperation with the CPU may function as such units. The CPU and a control circuit that controls the operation of an image processing apparatus may cooperate to implement such units. The CPU need not be a single one, and there may be a plurality of CPUs. In such a case, the plurality of CPUs may perform processing in a distributed manner. The plurality of CPUs may be arranged in one computer or in a plurality of physically different computers. The units realized by the CPU(s) executing a program or programs may be realized by a dedicated circuit or circuits.

### (Image Registration Processing)

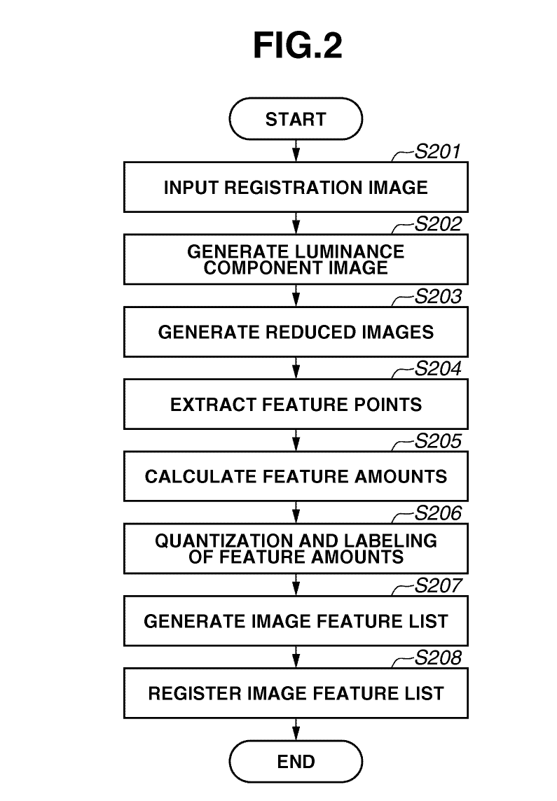

FIG. 2 is a flowchart illustrating an image registration processing of the image retrieval apparatus according to the first exemplary embodiment. The flowchart is implemented by the CPU(s) executing a control program.

In step S201, the image retrieval apparatus receives a registration image via the image input unit 101. The received registration image is stored in the storage unit 107.

Next, the image feature calculation unit 102 performs the processing of steps S202 to S207. In step S202, the image feature calculation unit 102 extracts luminance components from the received registration image, and generates a luminance component image based on the extracted luminance components.

In step S203, the image feature calculation unit 102 reduces the luminance component image according to a magnification (reduction ratio) p repeatedly in succession to generate n reduced images into which the luminance component image of the original size is reduced stepwise. The n reduced images include the original luminance component image. The magnification p and the number n of reduced images are determined in advance.

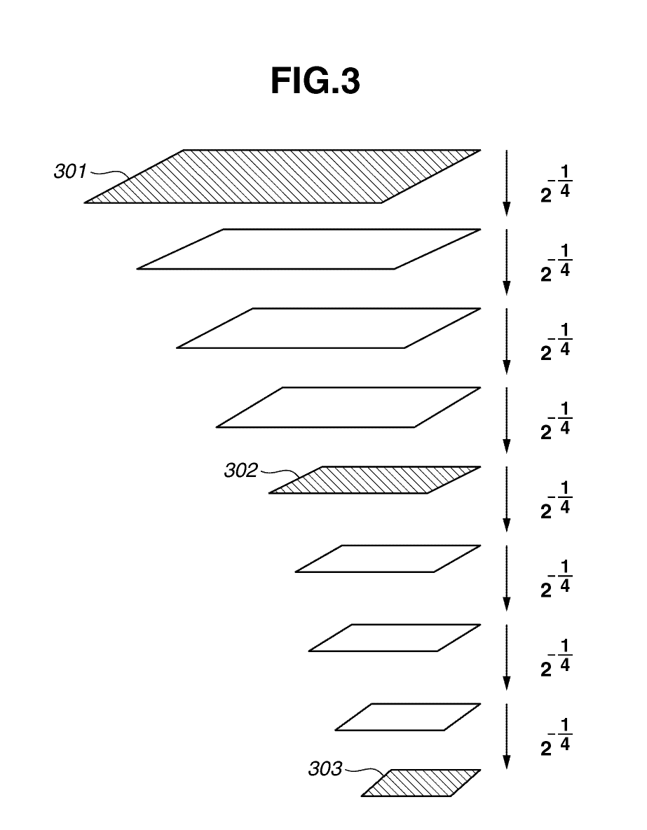

FIG. 3 is a diagram illustrating an example of reduced image generation processing. In the example illustrated in FIG. 3, the magnification p is the (−¼)-th power of 2 and the number n of reduced images is 9. The magnification p need not necessarily be the (−¼)-th power of 2. In FIG. 3, a luminance component image 301 generated in step S202 is recursively subjected to the reduction processing according to the magnification p four times to obtain a reduced image 302. The luminance component image 301 is recursively subjected to the reduction processing according to the magnification p eight times to obtain a reduced image 303.

In this example, the reduced image 302 is the luminance component image 301 reduced to ½. The reduced image 303 is the luminance component image 301 reduced to ¼. In the first exemplary embodiment, a linear interpolation-based reduction method is used to generate the reduced images. The image reduction may be performed by other methods.

In step S204, the image feature calculation unit 102 extracts local feature points that can be robustly extracted even if the n reduced images are each rotated. In the first exemplary embodiment, the Harris operator is used as a method for detecting such local feature points (see C. Harris and M. J. Stephens, “A combined corner and edge detector,” in Alvey Vision Conference, pages 147-152, 1988).

Specifically, the image feature calculation unit 102 applies the Harris operator to an image to obtain an output image H. With respect to a pixel on the output image H, the image feature calculation unit 102 examines the pixel values of the pixel of interest and eight pixels adjacent to that pixel (a total of nine pixels). The image feature calculation unit 102 extracts a point where the pixel of interest is a local maximum (the pixel of interest has the maximum pixel value among those of the nine pixels), as a local feature point. The pixel of interest may have a pixel value lower than or equal to a threshold value. In such a case, the image feature calculation unit 102 will not extract the point as a local feature point even if the pixel of interest is a local maximum.

The method for extracting feature points is not limited to the foregoing one using the Harris operator, and any method that can extract local feature points may be applied.

In step S205, for each of the local feature points extracted in step S204, the image feature calculation unit 102 calculates a feature amount (local feature amount) that is defined to be invariant even if the image is rotated. In the first exemplary embodiment, the image feature calculation unit 102 calculates such a local feature amount by using a combination of a local jet and derivatives thereof (see J. J. Koenderink and A. J. van Doorn, “Representation of local geometry in the visual system,” Biological Cybernetics, vol. 55, pp. 367-375, 1987).

Specifically, the image feature calculation unit 102 calculates a local feature amount v by using the following equation (1):

$$V = ( \begin{matrix}L \\ {L}_{x} {L}_{x} + {L}_{y} {L}_{y} \\ {L}_{xx} {L}_{x} {L}_{x} + 2 {L}_{xy} {L}_{x} {L}_{y} + {L}_{yy} {L}_{y} {L}_{y} \\ {L}_{xx} + {L}_{yy} \\ {L}_{xx} {L}_{xx} + 2 {L}_{xy} {L}_{xy} + {L}_{yy} {L}_{yy}\end{matrix} ) \qquad ( 1 )$$

The symbols used in the right side of equation (1) are defined by equations (2) to (7). G(x,y) on the right side of equation (2) is the Gaussian function. I(x,y) is the pixel value at coordinates (x,y) of the image. The symbol “*” represents a convolution operation. Equation (3) is the partial derivative of the variable L defined by equation (2) with respect to x. Equation (4) is the partial derivative of the variable L with respect to y. Equation (5) is the partial derivative of the variable Lx defined by equation (3) with respect to y. Equation (6) is the partial derivative of the variable Lx defined by equation (3) with respect to x. Equation (7) is the partial derivative of the variable Ly defined by equation (4) with respect to y.

$$\begin{matrix}L = G ( x , y ) * I ( x , y ) & ( 2 ) \\ {L}_{x} = \frac{\partial L}{\partial x} & ( 3 ) \\ {L}_{y} = \frac{\partial L}{\partial y} & ( 4 ) \\ {L}_{xy} = \frac{{\partial }^{2} L}{\partial x \partial y} & ( 5 )\end{matrix}$$

The method for calculating a local feature amount is not limited to the foregoing. Any method for calculating a feature amount may be applied.

In step S206, the image feature calculation unit 102 performs quantization and adds a label value to each of the local feature amounts calculated in step S205. According to the local feature amounts used in the first exemplary embodiment, i.e., the combination of a local jet and derivatives thereof, the image feature calculation unit 102 calculates an N-dimensional local feature amount from one local feature point. The image feature calculation unit 102 quantizes each dimension in K levels. N and K are determined in advance.

Specifically, the image feature calculation unit 102 performs quantization by using the following equation (8):

Qn=(Vn×K)/(Vnmax−Vnmin+1), (8)

where Qn is the quantized value of an n-th dimensional feature amount Vn of the N-dimensional local feature amount. Vnmax and Vnmin are a maximum possible value and a minimum possible value of the n-th dimensional feature amount, respectively.

After the quantization of all the dimensions, the image quantization calculation unit 102 performs labeling by using the following equation (9):

IDX=Σₙ₌₁^{N}K⁽ⁿ⁻¹⁾Qn (9)

The calculation methods for quantization and labeling are not limited to the foregoing. Any methods capable of quantization and labeling may be applied.

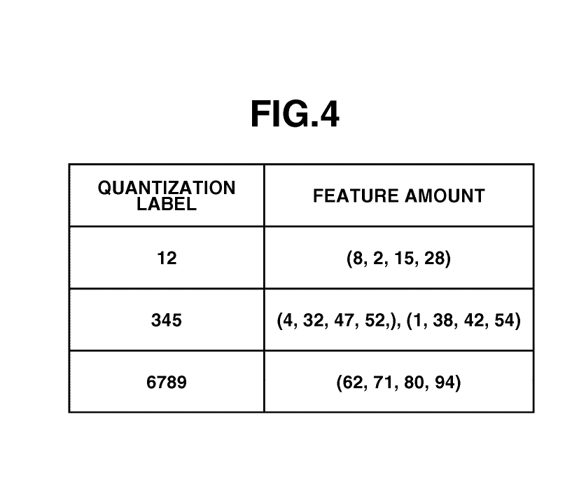

In step S207, the image feature calculation unit 102 summarizes the feature amounts and the quantization labels to make an image feature list. FIG. 4 illustrates an example of the image feature list. The image feature calculation unit 102 generates the image feature list with quantization labels as a key. One quantization label may be associated with a plurality of image feature lists.

In the first exemplary embodiment, the feature amounts and the quantization labels are summarized to make an image feature list. However, only the quantization labels may be summarized into an image feature list. Other information such as the coordinates of the feature points may be included in an image feature list.

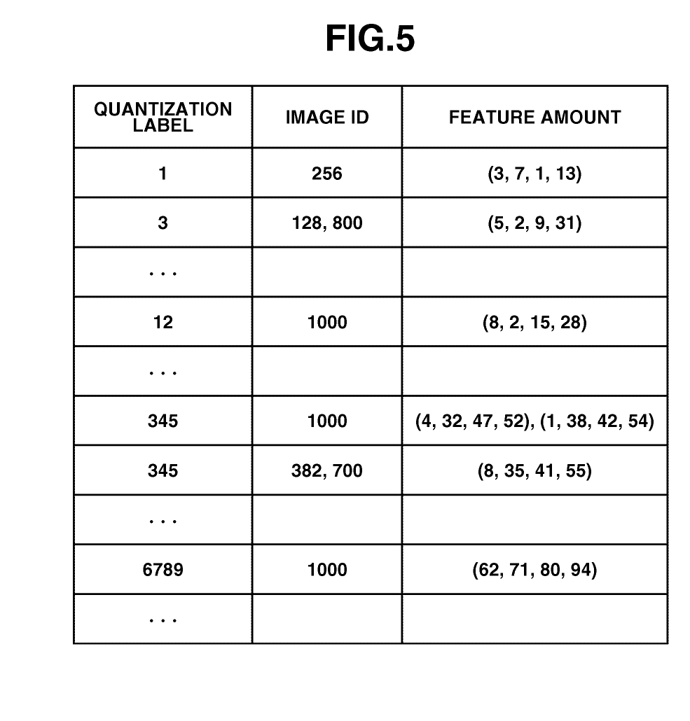

In step S208, the image feature calculation unit 102 registers the image feature list in the storage unit 107 in association with the registration image. FIG. 5 illustrates an example of a database in which image feature lists are registered in association with registered images. The image feature lists are registered in the database using quantization labels as a key. Image identifiers (IDs) are assigned to the registered images, and the image IDs are registered in the database. One quantization label can be associated with a plurality of image IDs if the same image is registered a plurality of times or if similar images are registered. Further, unused quantization labels may be present.

### (Differential Image Feature List Generation Processing)

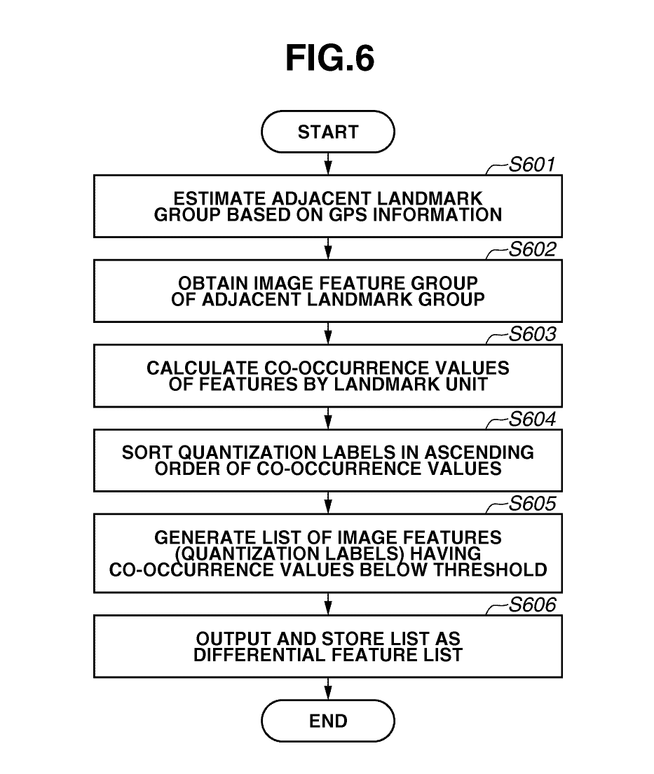

FIG. 6 is a flowchart illustrating an example of a differential image feature list generation processing of the differential image feature list generation unit 103 of the image retrieval apparatus. The flowchart is implemented by the CPU(s) executing a control program.

A differential image feature list refers to an image feature list that is generated based on a low degree of co-occurrences of image features. For example, co-occurrences of image features are determined in units of objects corresponding to the attribute information such as GPS-based position information, time information, and seasons. The differential image feature list has a high discrimination capability and is capable of differentiation. The differential image feature list is a partial list of image features described in the image feature list generated in step S207. Image features may be sorted in ascending order of co-occurrence values, and ones having co-occurrence values lower than or equal to a threshold may be summarized to make a differential image feature list.

The differential image feature list generation unit 103 prepares in advance images of object groups corresponding to respective pieces of attribute information, and determines the co-occurrences of image features object by object by referring to stored information about the image features. The differential image feature list generation unit 103 adopts image features in ascending order of the co-occurrences to generate an image feature list having a higher discrimination capability between images corresponding to the same attribute information.

The image feature selection unit 104 refers to image features in the differential image feature list. The image feature selection unit 104 selects image features having a higher discrimination capability, listed in the differential image feature list, from image features of a query image.

The present exemplary embodiment deals with an example where GPS is used to obtain information about photographing environment. In this example, the differential image feature list generation unit 103 generates a differential image feature list about landmarks. A knowledge base including GPS information about locations where landmarks exist and landmark images in pairs is constructed in advance.

In step S601, the differential image feature list generation unit 103 estimates an adjacent landmark group based on GPS information about the query image by using the knowledge base. In step S602, the differential image feature list generation unit 103 obtains image features of the adjacent landmark group. In step S603, the differential image feature list generation unit 103 calculates the co-occurrence values of image features in units of landmarks serving as objects to generate differential image features.

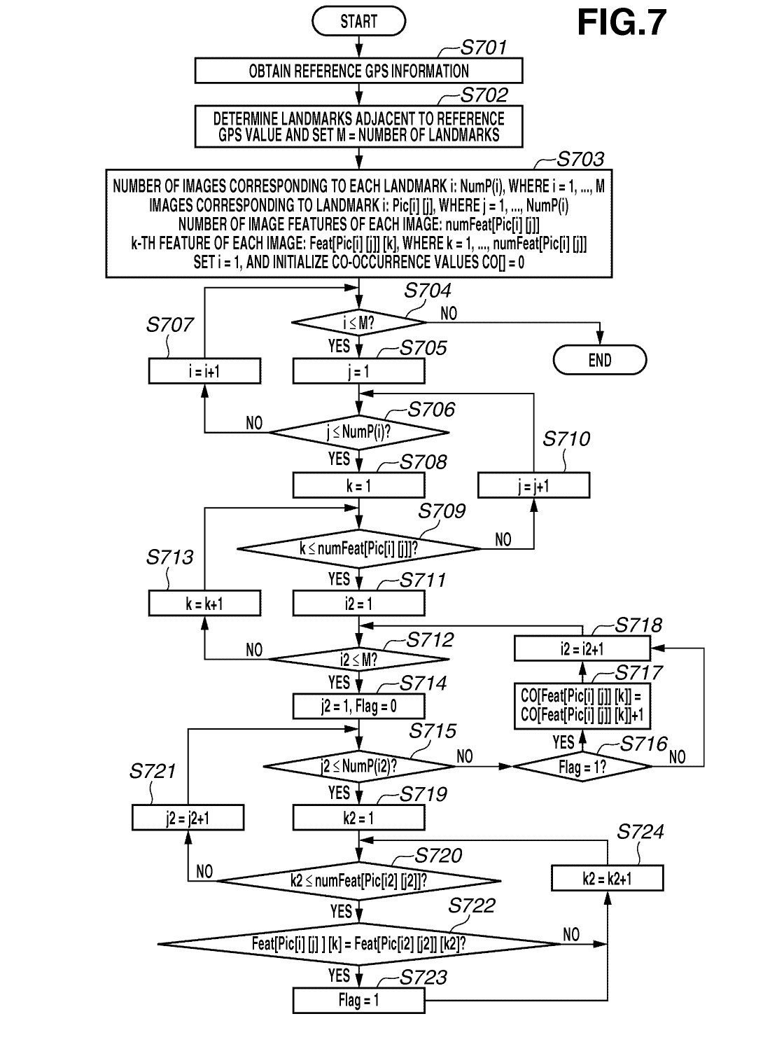

FIG. 7 is a flowchart illustrating an example of a processing for calculating co-occurrence values in step S603. The flowchart is implemented by the CPU(s) executing a control program.

In step S701, the differential image feature list generation unit 103 obtains GPS information serving as a reference when generating differential image features. As for the GPS information, the differential image feature list generation unit 103 may obtain in advance a list of GPS information about locations where famous landmarks are. In such a case, the differential image feature list generation unit 103 can perform the processing of FIG. 7 on each piece of the GPS information to handle a large number of landmarks. GPS information may be automatically generated at appropriate intervals.

In step S702, the differential image feature list generation unit 103 determines landmarks adjacent to a reference GPS value. M is a number of landmarks. A knowledge base in which landmarks, GPS values, image data, and image features are associated with each other may be prepared in advance. In such a case, the differential image feature list generation unit 103 may determine landmarks lying at distances within a predetermined value from the reference GPS value. The GPS information includes height information, although the height information may or may not be included in the knowledge base.

In step S703, the differential image feature list generation unit 103 reads the number of image features corresponding to the M landmarks and other values from the knowledge base into a memory. The values to be read include:

The number of images corresponding to each landmark i: NumP(i), where i=1, . . . , M;

Images corresponding to the landmark i: Pic[i][j], where j=1, . . . , NumP(i);

The number of image features of each image: numFeat[Pic[i][j]]; and

The k-th features of each image: Feat[Pic[i][j]][k], where k=1, . . . , numFeat[Pic[i][j]].

The differential image feature list generation unit 103 further sets i=1, and initializes the co-occurrence values CO[ ] of the image features to 0. In the array part [ ] of the co-occurrence values CO, the values of the quantization labels of the image features are entered.

In step S704, the differential image feature list generation unit 103 determines whether a counter for indicating a landmark to serve as a comparison reference is less than or equal to M, i.e., whether there is a landmark yet to serve as a comparison reference. If there is no such landmark (NO in step S704), the differential image feature list generation unit 103 ends the processing.

In the processing of steps S704 to S713, the differential image feature list generation unit 103 switches the landmark to serve as a comparison criterion up to M times, switches the image group of the landmark, and generates Feat[Pic[i][j]][k] for referring to the feature amounts of the images.

With reference to the feature amounts of all the images corresponding to the landmark, the differential image feature list generation unit 103 determines how much other images include the same feature amounts, in units of landmarks.

The feature amounts are all quantized and handled by quantization labels. (In the present exemplary embodiment, the differential image feature list generation unit 103 determines co-occurrences based not on the sameness of feature amounts but on the sameness of quantization labels.)

In step S705, the differential image feature list generation unit 103 initializes j to 1. j indicates what number an image has in the image group corresponding to the landmark i.

In step S706, the differential image feature list generation unit 103 determines whether j exceeds the number of images corresponding to the landmark i. If j exceeds the number of images (NO in step S706), then in step S707, the differential image feature list generation unit 103 increases i by one to switch to the next landmark. The differential image feature list generation unit 103 returns to step S704.

In step S706, if j is determined not to exceed the number of images corresponding to the landmark i (YES in step S706), then in step S708, the differential image feature list generation unit 103 initializes a counter k to 1. The counter k is intended to refer to a feature amount in step S709.

In step S709, the differential image feature list generation unit 103 determines whether k exceeds the number of feature amounts of the j-th image related to the landmark i. If j does not exceed the number of feature amounts (YES in step S709), then in step S711, the differential image feature list generation unit 103 initializes i2 to 1. i2 indicates a landmark to be compared. The differential image feature list generation unit 103 proceeds to the processing of steps S712 to S721 for referring to feature amounts Feat[Pic[i2][j2]][k2] of the landmark to be compared.

In step S709, if k is determined to exceed the number of feature amounts of the j-th image related to the landmark i (NO in step S709), then in step S710, the differential image feature list generation unit 103 increases j indicating the related image by one. The differential image feature list generation unit 103 returns to step S706.

In step S712, the differential image feature list generation unit 103 determines whether i2 indicating the landmark to be compared exceeds the number of landmarks M.

If i2 exceeds M (NO in step S712), then in step S713, the differential image feature list generation unit 103 increases k by one, and returns to the processing for updating feature amounts of the landmark serving as the comparison reference.

If the image features of the landmark i has all been compared, the differential image feature list generation unit 103 proceeds through steps S713, S709, S710, and S706 to step S707. In step S707, the differential image feature list generation unit 103 updates the comparison reference to the next landmark.

In the processing of steps S712 to S724, the differential image feature list generation unit 103 switches the landmark to be compared up to M times, switches the image group of the landmark, and generates Feat[Pic[i2][j2]][k2] for referring to the feature amount of the images. In step S722, the differential image feature list generation unit 103 performs comparison processing by using the referred feature amounts.

With reference to the feature amounts of all the images corresponding to the landmark, the differential image feature list generation unit 103 determines how much other images include the same feature amounts, in units of landmarks.

In step S714, the differential image feature list generation unit 103 initializes j2 to 1, and initializes Flag to 0 (not incremented). j2 indicates what number an image has in the image group corresponding to the landmark i2. Flag indicates whether the co-occurrence value of any image related to the landmark i2 has been incremented.

In step S715, the differential image feature list generation unit 103 determines whether j2 exceeds the number of images corresponding to the landmark i2. If j2 exceeds the number of images (NO in step S715), then in step S716, the differential image feature list generation unit 103 determines whether Flag is 1. If Flag is 1 (YES in step S716), then in step S717, the differential image feature list generation unit 103 increases the co-occurrence value corresponding to the quantization label of the feature amount by one.

In step S718, the differential image feature list generation unit 103 increases 12 by one to switch to the next landmark. The differential image feature list generation unit 103 returns to step S712.

In step S715, if j2 is determined not to exceed the number of images corresponding to the landmark i2 (YES in step S715), then in step S719, the differential image feature list generation unit 103 initializes a counter k2 to 1. The counter k2 is intended to refer to a feature amount.

In step S720, the differential image feature list generation unit 103 determines whether k2 exceeds the number of feature amounts of the j2-th image related to the landmark i2. If k2 does not exceed the number of feature amounts (YES in step S720), then in step S722, the differential image feature list generation unit 103 determines whether the feature amounts Feat[Pic[i][j]][k] and Feat[Pic[i2][j2]][k2] are the same. If the feature amounts Feat[Pic[i][j]][k] and Feat[Pic[i2][j2]][k2] are the same (YES in step S722), then in step S723, the differential image feature list generation unit 103 sets Flag to 1, which indicates that there have already been found the same image features. In step S722, if the feature amounts Feat[Pic[i][j]][k] and Feat[Pic[i2][j2]][k2] are determined not to be the same (NO in step S722), then in step S724, the differential image feature list generation unit 103 increases k2 by one. The differential image feature list generation unit 103 returns to step S720. If the image features of the landmark i2 has all been compared, the differential image feature list generation unit 103 proceeds through steps S724 and S720 to step S721. In step S721, the differential image feature list generation unit 103 updates the comparison target to the next landmark.

As a result, the co-occurrence values CO[ ] store co-occurrence values corresponding to the quantization labels of the feature amounts indicated by [ ]. Possible values of the co-occurrence range from 0 to M×M.

The differential image feature list generation unit 103 divides CO[ ] by M×M to normalize CO[ ] to values ranging from 0 to 1.0.

A co-occurrence value of 0 indicates that there appears no feature amount. The differential image feature list generation unit 103 sorts co-occurrence values greater than 0 in ascending order, and sorts the quantization labels of the feature amounts corresponding to the co-occurrence values accordingly. The sorting result of the quantization labels of the feature amounts serves as an information source for generating differential image features.

Suppose that a co-occurrence value is high, like 1.0 in an extreme case. Such a co-occurrence value indicates that the image feature is commonly included in all the landmarks, and is thus less useful in distinguishing landmarks. On the other hand, a low co-occurrence value indicates that the image feature is useful in distinguishing landmarks. In the present exemplary embodiment, image features having low co-occurrence values are positively used as differential image features.

In step S604, the differential image feature list generation unit 103 sorts the quantization labels in ascending order of the co-occurrence values.

In step S605, the differential image feature list generation unit 103 generates a list of image features (quantization labels) having co-occurrence values below a threshold. In step S606, the differential image feature list generation unit 103 outputs and stores the list as a differential image feature list. A co-occurrence value considered to have a discrimination capability is set as the threshold.

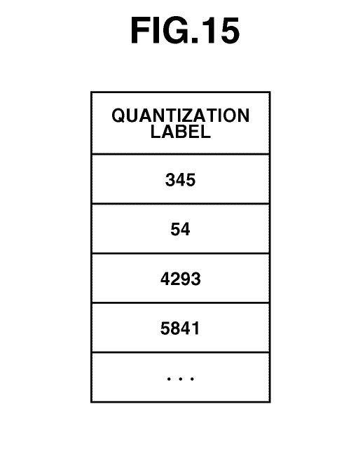

FIG. 15 illustrates an example of the differential image feature list.

In the processing of step S605, the differential image feature list generation unit 103 may select a predetermined number of co-occurrence values in ascending order instead of using the threshold. If there are a lot of landmarks near the reference GPS information, the differential image feature list generation unit 103 can desirably use co-occurrence values at least as many as or more than the number of landmarks. The differential image feature list generation unit 103 may change the predetermined number based on the number of landmarks. For example, the differential image feature list generation unit 103 may change the predetermined number to the number of landmarks multiplied by a certain number.

The differential image feature list generation unit 103 may generate a differential image feature list by using current GPS information on an on-demand basis, at timing such as when the image retrieval apparatus is powered on and when the image retrieval apparatus enters a photographing mode or an image retrieval mode.

Alternatively, the differential image feature list generation unit 103 may generate a plurality of differential image feature lists in advance, and select a differential image feature list according to GPS information. Considering the range where a landmark can be photographed in a certain size, GPS information about photographing positions may be appropriately quantized in sections of 100 meters square. The differential image feature list generation unit 103 may generate differential image feature lists in such quantization units in advance.

A method for improving the accuracy of differential image feature lists and reducing the size of each differential image feature list will be described. Images of each landmark are prepared in respective photographing azimuth directions. The differential image feature list generation unit 103 obtains a photographing azimuth direction from GPS information about a photographing position and GPS information about the positions of adjacent landmarks, and switches images to calculate co-occurrence values. In such a manner, the differential image feature list generation unit 103 can generate differential image feature lists based on the composition of landmarks that can be captured from the photographing position. Since the number of landmarks that can be photographed also decreases, each differential image feature list can be reduced in size.

If GPS information about the positions where landmarks exist and images of the landmarks cannot be prepared, a combination of GPS information and compass-based photographing azimuth direction information may be used instead. More specifically, captured images in all the directions of 360° around a GPS-based photographing position may be classified, for example, in units of 45°, or equivalently, into eight directions. The differential image feature list generation unit 103 may determine the co-occurrence values of image features with respect to such classifications.

In step S603, the differential image feature list generation unit 103 calculates the co-occurrence values of image features landmark by landmark. For simpler calculations, the differential image feature list generation unit 103 may use co-occurrence values of entire images including landmarks instead of landmark-by-landmark basis. In such a case, accuracy may be compromised.

The image retrieval apparatus may present images of a landmark to a person and have the person specify characteristic area of the landmark while performing image feature extraction processing to detect feature points. The differential image feature list generation unit 103 then performs the processing of FIG. 6 by using only feature points lying in the area specified by the person, whereby a differential image feature list having high accuracy can be generated. The image retrieval apparatus may further visualize and display the feature points and their co-occurrence values corresponding to the differential image feature list, and have the person select feature points to generate a differential image feature list that is more compact and closer to human sense. The image retrieval apparatus may calculate image features from feature points related to a portion that a person considers is characteristic of a landmark, and display the number of images stored in association with the image features or co-occurrence values of the image features. The differential image feature list generation unit 103 may generate a differential image feature list in consideration of the number of images or the co-occurrence values.

### (Image Retrieval Processing)

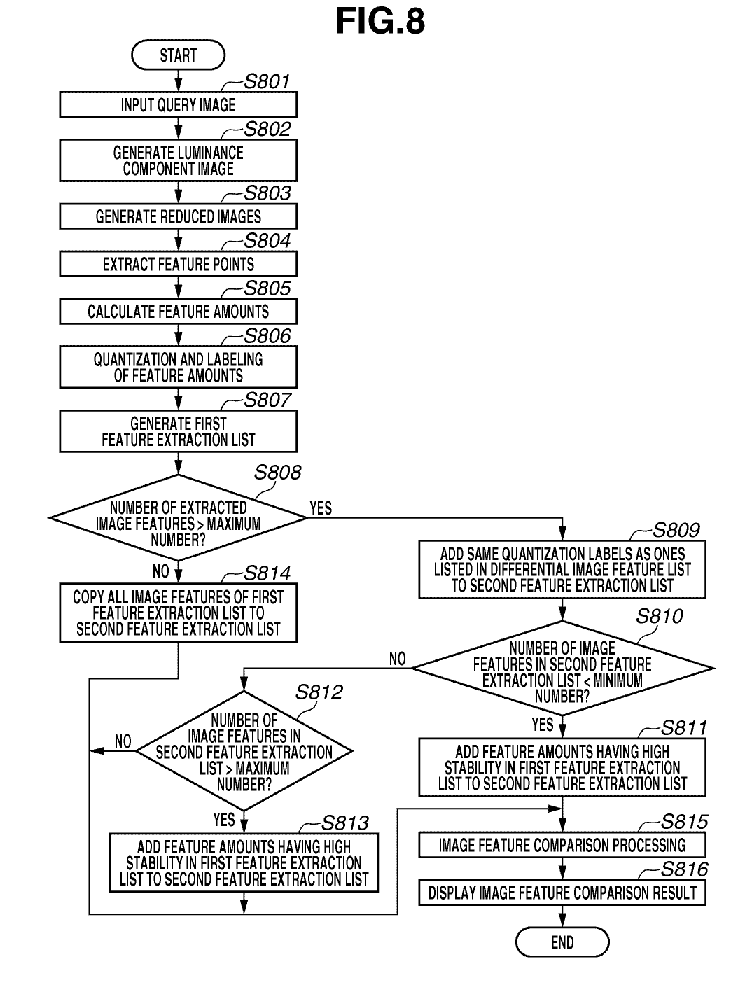

FIG. 8 is a flowchart illustrating an example of an image retrieval processing of the image retrieval apparatus according to the first exemplary embodiment. The flowchart is implemented by the CPU(s) executing a control program.

In step S801, the user inputs a query image via the image input unit 101. The input query image is stored in the storage unit 107.

Next, the image feature calculation unit 102 performs the processing of steps S802 to S807. This processing is similar to the processing of steps S202 to S207 in the image registration processing. A detailed description thereof will be omitted.

Note that the image feature calculation unit 102 uses two types of image feature extraction lists, which include a first feature extraction list and a second feature extraction list. The first feature extraction list simply includes image features extracted from the query image. The second feature extraction list includes image features modified so that image features matching image features included in a differential image feature list are preferentially used for the comparison processing of the image feature comparison unit 105.

The image feature list in the image registration processing corresponds to the first feature extraction list in the image retrieval processing. The second feature extraction list is used to store image features for use in final retrieval comparison processing.

In step S808, if the number of image features extracted from the query image is greater than the maximum number of features usable for a retrieval (YES in step S808), the image retrieval apparatus proceeds to step S809. If the number of extracted image features is less than or equal to the maximum number (NO in step S808), the image retrieval apparatus proceeds to step S814.

The reason for limiting the number of image features to or below the maximum number is to control the upper limit of the number of image features used for a retrieval and thereby reduce variations in the retrieval processing time. Even if the number of extracted image features is less than or equal to the maximum number, the image retrieval apparatus can proceed to step S809 and may be able to produce a favorable outcome. When the number of image features obtained from the query image is extremely small in the first place, care needs to be taken not to excessively reduce the number of image features.

In the first exemplary embodiment, the image retrieval apparatus makes the determination based on whether the number of feature points of the query image is greater than the maximum number of feature points usable for a retrieval. However, the image retrieval apparatus may make the determination based on whether the first feature extraction list stored in the storage unit 107 has a size greater than the maximum size usable for a retrieval.

In step S809, the image retrieval apparatus adds the same quantization labels as ones listed in the differential image feature list to a second feature extraction list. The image retrieval apparatus may delete quantization labels not listed in the differential image feature list from the first feature extraction list so that image features having a high discrimination capability remain in the first feature extraction list. Alternatively, identifiers indicating whether the quantization labels are listed in the differential image feature list may be added to the first feature extraction list.

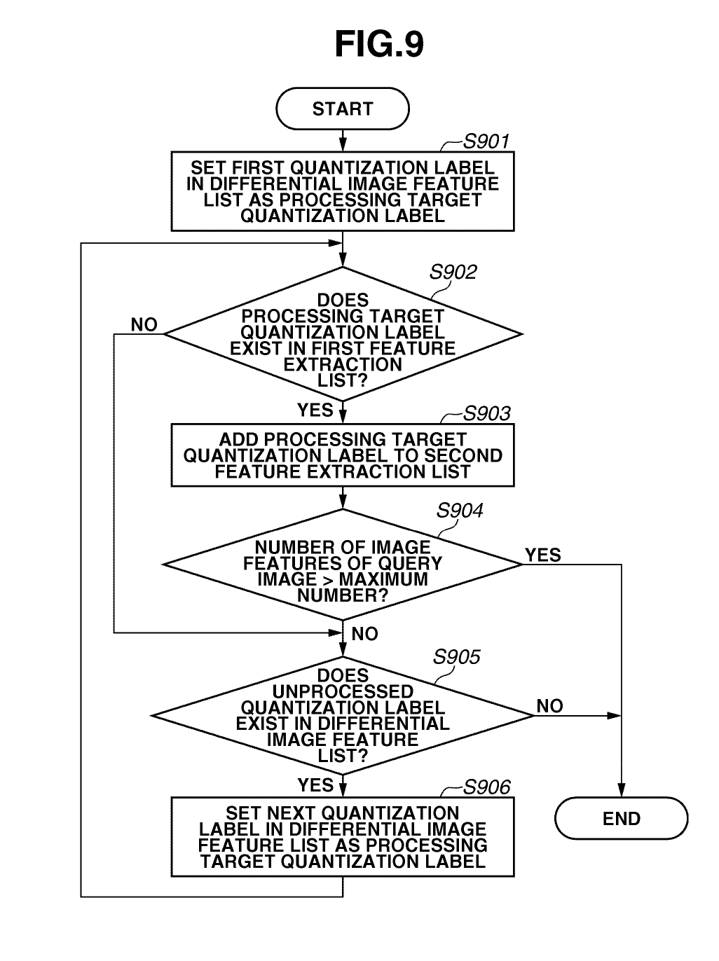

FIG. 9 is a flowchart illustrating an example of processing for adding the same quantization labels as ones listed in the differential image feature list to the second feature extraction list in step S809. The flowchart is implemented by the CPU(s) executing a control program. This processing is performed by the image feature selection unit 104.

In step S901, the image feature selection unit 104 sets the first quantization label in the differential image feature list as a processing target quantization label. In step S902, if the processing target quantization label exists in the first feature extraction list of the query image (YES in step S902), the image feature selection unit 104 proceeds to step S903. If not (NO in step S902), the image feature selection unit 104 proceeds to step S905.

In step S903, the image feature selection unit 104 adds the processing target quantization label to the second feature extraction list. In step S904, if the number of image features of the query image is less than or equal to the maximum number of image features usable for a retrieval (NO in step S904), the image feature selection unit 104 proceeds to step S905. If the number of image features is greater than the maximum number (YES in step S904), the image feature selection unit 104 ends the processing.

In the first exemplary embodiment, the image feature selection unit 104 makes the determination based on whether the number of feature points of the query image is greater than the maximum number of feature points usable for a retrieval. Like step S808, the image feature selection unit 104 may make the determination based on whether the second feature extraction list stored in the storage unit 107 has a size greater than the maximum size usable for a retrieval.

In step S905, if an unprocessed quantization label exists in the differential image feature list (YES in step S905), the image feature selection unit 104 proceeds to step S906. If not (NO in step S905), the image feature selection unit 104 ends the processing.

In step S906, the image feature selection unit 104 sets the next quantization label in the differential image feature list as the processing target quantization label. The image feature selection unit 104 returns to step S902.

After the end of the processing in step S809, then in step S810, if the number of image features in the second feature extraction list is less than the minimum number of image features needed for a retrieval (YES in step S810), the image feature selection unit 104 proceeds to step S811. If the number of image features is greater than or equal to the minimum number (NO in step S810), the image feature selection unit 104 proceeds to step S812.

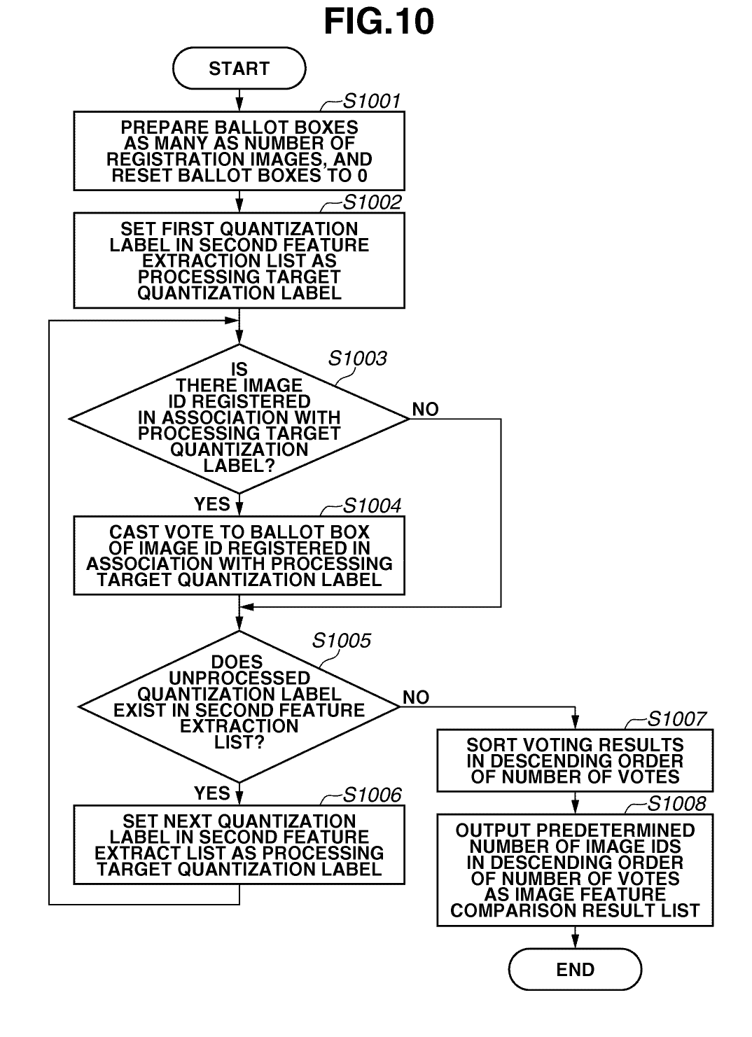

For the purpose of a feature point-based image retrieval, or voting type matching such as illustrated in FIG. 10 in particular, it is empirically known that at least around ten feature points need to be included in a landmark area. Otherwise, information may be insufficient. If the number of image features added from the differential image feature list is less than the minimum number, then in step S811, the image feature selection unit 104 adds image features.

In the first exemplary embodiment, the image feature selection unit 104 makes the determination based on whether the number of feature points of the query image is greater than the minimum number of feature points needed for a retrieval. Like step S808, the image feature selection unit 104 may make the determination based on whether the second feature extraction list stored in the storage unit 107 has a size greater than the minimum size needed for a retrieval.

In step S811, the image feature selection unit 104 evaluates the stability of feature amounts that are included in the first feature extraction list of the query image and not yet in the second feature extraction list. The image feature selection unit 104 then adds feature amounts having high stability to the second feature extraction list, thereby adding feature points of the query image up to the maximum number of image features usable for a retrieval. If the number of image features in the second feature extraction list still falls below the minimum number, the image feature selection unit 104 uses other image features. To select feature points by utilizing the stability of the feature amounts of the query image, the image feature selection unit 104 can use the method according to Japanese Patent Application No. 2011-237962.

More specifically, the image feature selection unit 104 determines the positions of feature points and the feature-to-feature distances of feature amounts resulting from image processing such as rotation and reduction of the image to be analyzed, and uses the positions and the distances as stability indexes. It is clear that the feature amounts change if the positions of the feature points vary greatly. The image feature selection unit 104 therefore narrows feature points down to ones falling within a given threshold range in position. The image feature selection unit 104 then determines changes in the feature amounts, i.e., distances between the feature amounts before and after the image processing such as rotation and reduction, and use the distances as stability indexes. It is considered that the smaller the distance, the higher the stability of the feature point. The image feature selection unit 104 sorts the feature amounts in ascending order of the distance, and generates an image feature list of the query image by using preferentially the feature amounts of higher stability until the number of feature points reaches the maximum number of feature points usable for a retrieval.

In step S812, if the number of image features in the second feature extraction list is greater than the maximum number of image features usable for a retrieval (YES in step S812), the image feature selection unit 104 proceeds to step S813. If the number of image features in the second feature extraction list is less than or equal to the maximum number (NO in step S812), the image feature selection unit 104 proceeds to step S815.

In step S813, the image feature selection unit 104 preferentially selects image features in ascending order of the co-occurrence values from the image features in the second feature extraction list including only differential image features, up to the maximum number usable for the comparison processing by the image feature comparison unit 105. The image feature selection unit 104 stores the selected image features as a new second feature extraction list. The image feature selection unit 104 may select image features at random up to the maximum number usable for the comparison processing by the image feature comparison unit 105, although in that case performance may be compromised.

In step S814, the image feature selection unit 104 employs all the image features in the first feature extraction list since the number of image features does not reach the maximum number. The image feature selection unit 104 copies all the image features in the first feature extraction list to the second feature extraction unit.

In step S815, the image feature comparison unit 105 reads the image features from the storage unit 107 and performs image feature comparison processing. FIG. 10 is a flowchart illustrating an example of the image feature comparison processing in step S815. The flowchart is implemented by the CPU(s) executing a control program.

In step S1001, the image feature comparison unit 105 prepares ballot boxes as many as the number of registered images, and resets the ballot boxes to zero. In step S1002, the image feature comparison unit 105 sets the first quantization label in the second feature extraction list as a processing target quantization label.

In step S1003, if there is an image ID registered in association with the processing target quantization label (YES in step S1003), the image feature comparison unit 105 proceeds to step S1004. If there is no such image ID (NO in step S1003), the image feature comparison unit 105 proceeds to step S1005. In step S1004, the image feature comparison unit 105 casts a vote to the ballot box of the image ID registered in association with the processing target quantization label.

In step S1005, if an unprocessed quantization label exists in the second feature extraction unit (YES in step S1005), the image feature comparison unit 105 proceeds to step S1006. If not (NO in step S1005), the image feature comparison unit 105 proceeds to step S1007.

In step S1006, the image feature comparison unit 105 sets the next quantization label in the second feature extraction list as the processing target quantization label. The image feature comparison unit 105 returns to step S1003.

In step S1007, the image feature comparison unit 105 sorts the voting results in descending order of the number of votes. In step S1008, the image feature comparison unit 105 outputs a predetermined number of image IDs in descending order of the number of votes as an image feature comparison result list.

In step S816, the image feature comparison result display unit 106 displays the image feature comparison result. To display the image feature comparison result, the image feature comparison display unit 106 displays both the image IDs and the corresponding images.

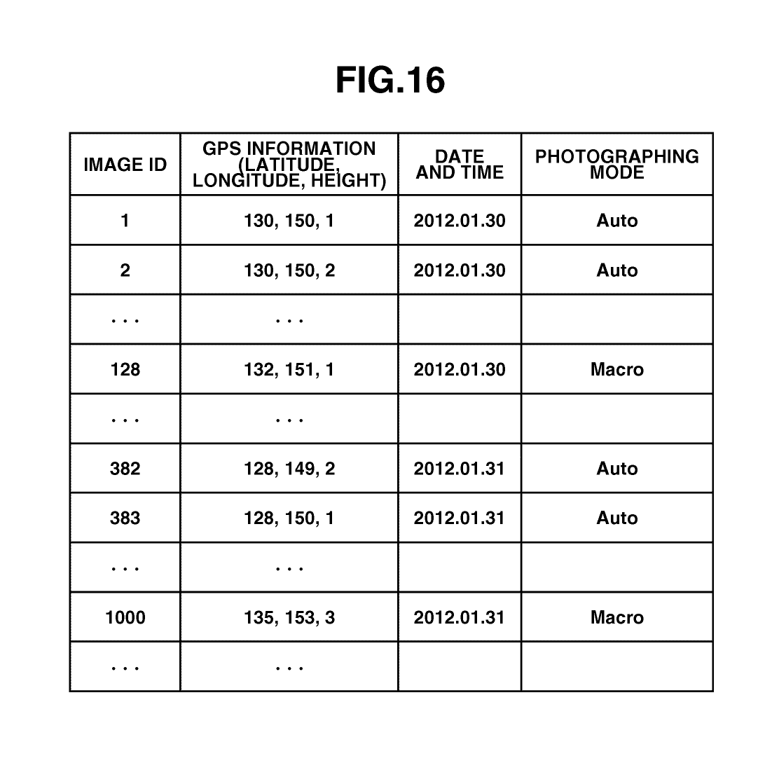

Landmarks are stationary and thus have unique GPS information. When retrieving only for landmarks, the image feature comparison unit 105 therefore may perform, in step S1008, processing for referring to image attribute data illustrated in FIG. 16 and narrowing images down to ones having GPS information within the photographable range from the current GPS information of the image retrieval apparatus. Any object that is stationary and can be associated with unique GPS information like a landmark can be similarly processed.

As described above, in the first exemplary embodiment, the image retrieval apparatus preferentially adopts highly-differentiable image features of the differential image feature list describing image features unique to landmarks using GPS information, from among the image feature list extracted from the query image. The image retrieval apparatus tries to avoid using image features of the image features extracted from the query image that are not included in the differential image feature list and have lower stability. This can narrow feature amounts down to ones having a high discrimination capability. The image retrieval apparatus performs a retrieval by using the selected image features. As a result, even if the number of feature points usable for a retrieval is limited, the retrieval can be performed with reduced deterioration in the retrieval accuracy.

A second exemplary embodiment of the present invention will be described below with reference to the drawings. The second exemplary embodiment deals with an example of an image retrieval system, in which a retrieval client (request source) serving as an image retrieval terminal captures an image to generate a query image, extracts image features, and transmits the image features to an image retrieval server. The image retrieval server performs a retrieval inside. The retrieval result is displayed on the retrieval client. The retrieval client is a query image providing apparatus. Image registration processing for the image retrieval server is performed by a similar method to that of the first exemplary embodiment.

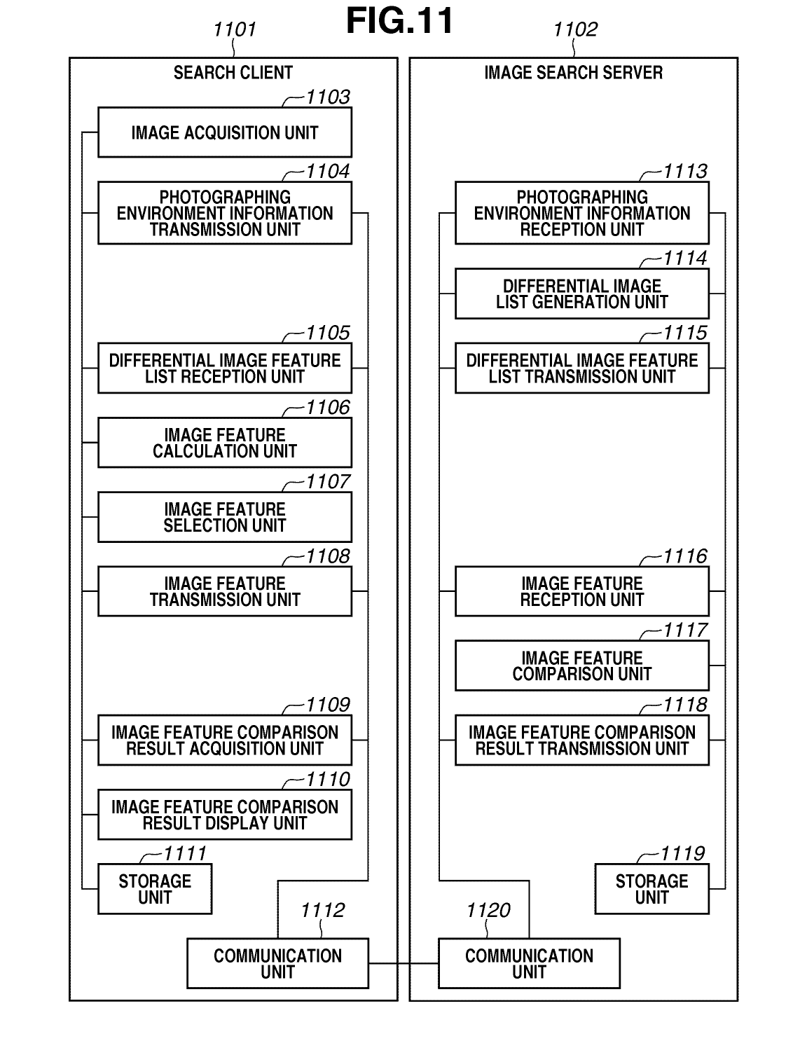

FIG. 11 is a block diagram illustrating a functional configuration example of the image retrieval system according to the present exemplary embodiment. The operation of the components illustrated in FIG. 11 will be described in detail below.

The image retrieval system illustrated in FIG. 11 includes a retrieval client 1101 and an image retrieval server 1102. The retrieval client 1101 and the image retrieval server 1102 include communication units 1112 and 1120, respectively. The communication units 1112 and 1120 are connected to each other by a network (wired or wireless), and perform information communication via the network.

In the retrieval client 1101, an image acquisition unit 1103 obtains a query image by photographing with a camera. In the present exemplary embodiment, a photographing environment information transmission unit 1104 transmits GPS information to the image retrieval server 1102.

A differential image feature list reception unit 1105 receives a differentiable image feature list generated by the image retrieval server 1102 via the communication unit 1112.

Suppose, for example, that there is a plurality of landmarks that can be captured from the current photographing position, and the retrieval client 1101 is to receive feature amounts serving to distinguish the landmarks in the form of a differential image feature list. The retrieval client 1101 transmits GPS information to the image retrieval server 1102, and receives a differential image feature list associated with the GPS information via the communication unit 1112. The differential image feature list may describe, for example, differential image features serving to distinguish an object group that is assumed to be captured in the photographing position and in a relevant season, by using GPS information and date and time information. Such a differential image feature list can significantly improve the retrieval accuracy.

An image feature calculation unit 1106 calculates image features of the query image obtained by the image acquisition unit 1103. An image feature selection unit 1107 selects image features having a high discrimination capability from the image features of the query image. An image feature transmission unit 1108 transmits the image features selected by the image feature selection unit 1107 to the image retrieval server 1102 via the communication unit 1112. An image feature comparison result acquisition unit 1109 receives a result of image feature comparison performed by the image retrieval server 1102 via the communication unit 1112. An image feature comparison result display unit 1110 displays the image feature comparison result obtained by the image feature comparison result acquisition unit 1109. A storage unit 1111 is a memory or HDD that stores data being processed in the retrieval client 1101.

In the image retrieval server 1102, a differential image feature list generation unit 1114 generates an image feature list having a high discrimination capability between images that have low frequencies of occurrence with respect to the same attribute information and correspond to the same photographing environment information among image features calculated from a plurality of registration images.

A differential image feature list transmission unit 1115 transmits a differentiable image feature list conforming to photographing environment information obtained from a photographing environment information reception unit 1113, to the retrieval client 1101 via the communication unit 1120. An image feature reception unit 1116 receives the image features of the query image calculated by the retrieval client 1101 and preferentially adopted by the image feature selection unit 1107 via the communication unit 1120. An image feature comparison unit 1117 performs an image feature comparison by using the image features of the query image received by the image feature reception unit 1116. An image feature comparison result transmission unit 1118 transmits the result of the image feature comparison performed by the image feature comparison unit 1117 to the retrieval client 1101 via the communication unit 1120. A storage unit 1119 is a memory or HDD that stores data being processed in the image retrieval server 1102.

The image feature selection unit 1107 may be provided on the image retrieval server 1102 side. In such a case, the image feature transmission unit 1108 transmits the image features of the query image extracted by the image feature extraction unit 1106 to the image retrieval server 1102 via the communication unit 1112. The image feature selection unit 1107 in the image retrieval server 1102 selects image features having a high discrimination capability from the image features of the query image. The image feature comparison unit 1117 performs the image feature comparison by using the image features selected by the image feature selection unit 1107 on the image retrieval server 1102 side. In such a case, the flowchart of an image retrieval processing procedure is also modified so that the image feature selection unit 1107 performs its processing on the image retrieval server 1102 side.

The foregoing components are comprehensively controlled by a not-illustrated CPU.

The CPU can execute a program or programs to function as various units. An ASIC or other control circuits operating in cooperation with the CPU may function as such units. The CPU and a control circuit that controls the operation of an image processing apparatus may cooperate to implement such units. The CPU need not be a single one, and there may be a plurality of CPUs. In such a case, the plurality of CPUs may perform processing in a distributed manner. The plurality of CPUs may be arranged in one computer or in a plurality of physically different computers. The means implemented by the CPU(s) executing a program or programs may be implemented by a dedicated circuit or circuits.

### (Differential Image Feature List Generation Processing)

The differential image feature list generation unit 1114 in the image retrieval server 1102 of the image retrieval system according to the second exemplary embodiment performs differential image feature list generation processing similar to that of the differential image feature list generation unit 103 in the image retrieval apparatus according to the first exemplary embodiment. A detailed description thereof will be omitted.

To receive a differential image feature list for each retrieval increases processing load. The retrieval client 1101 can cache the differential image feature list in the case where the GPS information is same.

### (Image Retrieval Processing)

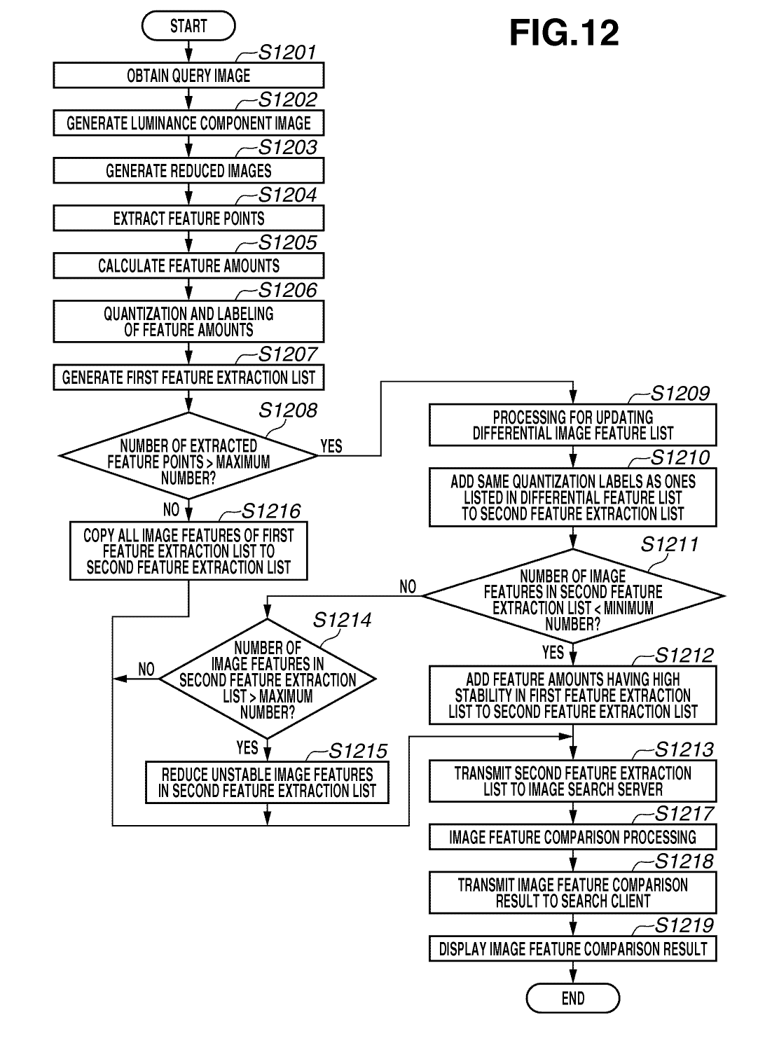

FIG. 12 is a flowchart illustrating an example of an image retrieval processing of the image retrieval system according to the second exemplary embodiment. The flowchart is implemented by the CPU(s) executing a control program.

In step S1201, the retrieval client 1101 obtains a query image via the image acquisition unit 1103 by photographing with a camera. The obtained image is stored in the storage unit 1111.

Next, the image feature calculation unit 1106 performs the processing of steps S1202 to S1207. This processing is similar to the processing of steps S202 to S207 in the image registration processing according to the first exemplary embodiment or the processing of steps S802 to S807 in the image retrieval processing according to the first exemplary embodiment. A detailed description thereof will be omitted.

In step S1208, if the number of feature points extracted from the query image is greater than the maximum number of feature points usable for a retrieval (YES in step S1208), the retrieval client 1101 proceeds to step S1209. If the number of extracted feature points is less than or equal to the maximum number (NO in step S1208), the retrieval client 1101 proceeds to step S1213.

In the second exemplary embodiment, the retrieval client 1101 makes the determination based on whether the number of feature points of the query image is greater than the maximum number of feature points usable for a retrieval. However, the retrieval client 1101 may make the determination based on whether the first feature extraction list stored in the storage unit 1111 has a size greater than the maximum size usable for a retrieval.

In step S1209, the retrieval client 1101 performs processing for updating the differential image feature list.

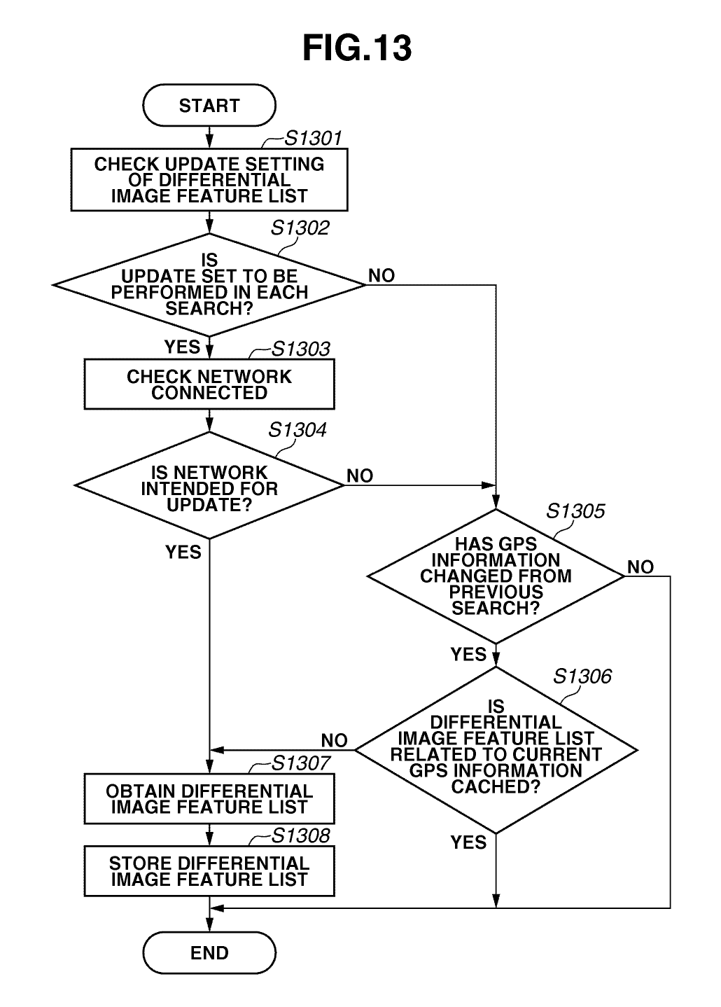

FIG. 13 is a detailed flowchart of step S1209, illustrating an example of the processing for updating the differential image feature list. The flowchart is implemented by the CPU(s) executing a control program.

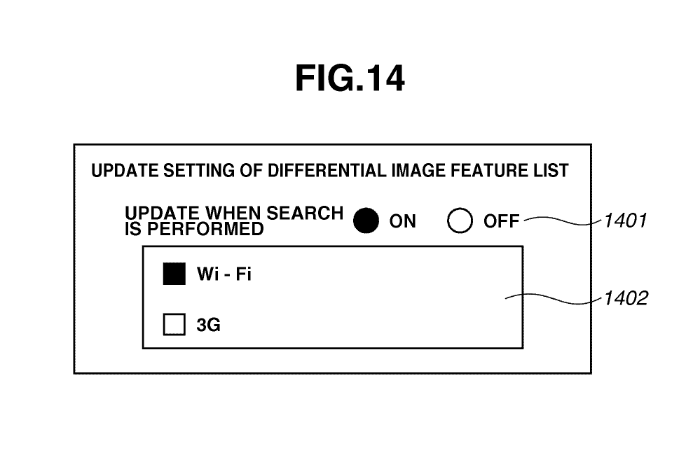

In step S1301, the retrieval client 1101 checks an update setting of the differential image feature list. The update setting of the differential image feature list indicates whether to perform an update for each retrieval. If an update is set to be performed for each retrieval, the update setting further indicates network connection in which the update is carried out. FIG. 14 illustrates an example of a user interface for making the update setting of the differential image feature list. In FIG. 14, buttons 1401 are used to set whether to perform an update for each retrieval. Buttons 1402 are used to set network connection in which the update is carried out.

In step S1302, if the update is set to be performed for each retrieval (YES in step S1302), the retrieval client 1101 proceeds to step S1303. If the update is set not to be performed (NO in step S1302), the retrieval client 1101 proceeds to step S1305.

In step S1303, the retrieval client 1101 checks the network being connected. In step S1304, if the network is intended for update (YES in step S1304), the retrieval client 1101 proceeds to step S1307. If the network is not intended for update (NO in step S1304), the retrieval client 1101 proceeds to step S1305.

In step S1305, if the GPS information has changed from the previous retrieval (YES in step S1306), the retrieval client 101 proceeds to step S1306. If the GPS information has not changed (NO in step S1306), the retrieval client 1101 simply uses the currently retained differential image feature list as a cache, and ends the update processing.

In step S1306, the retrieval client 1101 checks whether the differential image feature list related to the current GPS information has been cached. If the differential image feature list has not been cached (NO in step S1306), the retrieval client 1101 proceeds to step S1307. If the differential image feature list has been cached (YES in step S1306), the retrieval client 1101 simply uses the cache, and ends the update processing.

In step S1307, the differential image feature list reception unit 1105 obtains a differential image feature list from the image retrieval server 1102 via the communication unit 1112. In step S1308, the retrieval client 1101 stores the differential image feature list received in step S1307 into the storage unit 1111, and ends the processing for updating the differential image feature list.

After the end of the processing for updating the differential image feature list in step S1209, then in steps S1210 to S1212, the retrieval client 1101 performs processing for adding image features having high stability to the second feature extraction list from the first feature extraction list. The processing of steps S1210 to S1212 is similar to that of steps S809 to S811 in the image retrieval processing of the first exemplary embodiment. A detailed description thereof will be omitted.

In step S1213, the retrieval client 1101 transmits the extracted and selected second feature extraction list of the query image to the image retrieval server 1102 via the communication unit 1112.

In step S1217, the image retrieval server 1102 performs image feature comparison processing. This processing is similar to the processing of step S815 in the image retrieval processing according to the first exemplary embodiment. A detailed description thereof will be omitted. In step S1218, the image retrieval server 1102 transmits the image feature comparison result obtained in step S1212 to the retrieval client 1101 via the communication unit 1120.

In step S1219, the retrieval client 1101 displays the image feature comparison result. This processing is similar to the processing of step S816 in the image retrieval processing according to the first exemplary embodiment.

As described above, according to the second exemplary embodiment, the retrieval client 1101 extracts image features from a query image. From the image features, the retrieval client 1101 preferentially selects differential image features to be used for the comparison processing in an image retrieval. The retrieval client 1101 transmits the selected image features to the image retrieval server 1102, and the image retrieval server 1102 performs a retrieval. Consequently, even if the number of feature points usable for a retrieval is limited, the image retrieval server 1102 can perform the retrieval with reduced deterioration in the retrieval accuracy.

By using the GPS information (photographing location category) and date and time, the image retrieval server 1102 can generate a differential image feature list that enables an accurate retrieval for animals and plants that can be photographed in that location at that time. The image retrieval server 1102 can also generate a differential image feature list of information about nocturnal insects and/or animals whose probability of appearance varies depending on weather and time. The time information needs to be processed by local time.

The image retrieval server 1102 can further generate a differential image feature list about insects and/or animals whose frequency of appearance varies depending on weather, temperature, and/or humidity.

Differential image features are also useful for buildings having a movable body that changes its appearance, like a dome that is retractable depending on weather.

For alpine animals and plants, photographing altitude information of GPS information may be used. Atmospheric pressure may be used instead to estimate the altitude.

Attribute information may include the presence or absence of a flash and a dial setting of a camera photographing mode such as macro photography. Using such attribute information, the image retrieval server 1102 may determine image features having low co-occurrences between frequently-captured objects to generate a differential image feature list that enables an accurate retrieval.

Telephotography can be used to photograph birds that are difficult to approach. In such a case, the image retrieval server 1101 may determine image features having low co-occurrences between birds to generate a differential image feature list that enables an accurate retrieval. If a camera photographing mode for specifying an object attribute itself of a photographing object can be designated, the image retrieval server 1102 may generate a differential image feature list from images having the attribute.

A third exemplary embodiment of the present invention will be described below with reference to the drawings. The third exemplary embodiment deals with an example of an image retrieval apparatus which extracts image features from a query image, performs a retrieval by using the image features, and displays a retrieval result.

For an image retrieval using local feature amounts, the image retrieval apparatus extracts a plurality of local feature points from an image and compares local feature amounts calculated from the respective local feature points with each other for matching. If a large number of local feature points are extracted from a query image, the number of comparisons between local feature amounts increases which lowers the retrieval speed. The number of local feature points is therefore desirably not excessively large. In particular, common feature amounts included in a large number of images have a low discrimination capability against other images and are thus inefficient for a retrieval. Feature points having such feature amounts are desirably excluded.

Portable devices having a photographing function and a communication function are increasing. Examples include mobile phones, smartphones, and digital cameras. In a possible application, a personal computer (PC) or server may perform a retrieval with an image captured by such a portable device as a query, and display the retrieval result on the portable device. One method for achieving this includes calculating local feature amounts in the portable device and transmitting the local feature amounts to the PC or server. If the local feature amounts calculated in the portable device are large in size, it takes time to transmit the local feature amounts to the PC or server, in which case the time until a retrieval result is displayed can increase. The number of local feature points is therefore desirably not excessively large. Depending on the limitations of the portable device, PC or server, and/or communication lines, there may be an upper limit to the size of the local feature amounts.

Under the circumstances, as discussed in Japanese Patent Application Laid-Open No. 2011-43969 and Japanese Patent Application No. 2011-237962, it is conceivable to use not all but some of local feature points extracted. These methods are intended to narrow local feature points extracted from a query image down to stably extracted ones. For example, local feature amounts calculated from such stably extracted local feature points may be the ones frequently calculated from various images. In such a case, a retrieval using the local feature amounts has only a low discrimination capability against other images and fails to provide high retrieval accuracy.

The third exemplary embodiment of the present invention has been achieved in view of the foregoing problem. The third exemplary embodiment is directed to a technique for obtaining local feature points and local feature amounts that have a high discrimination capability against other images and are significant for a retrieval.

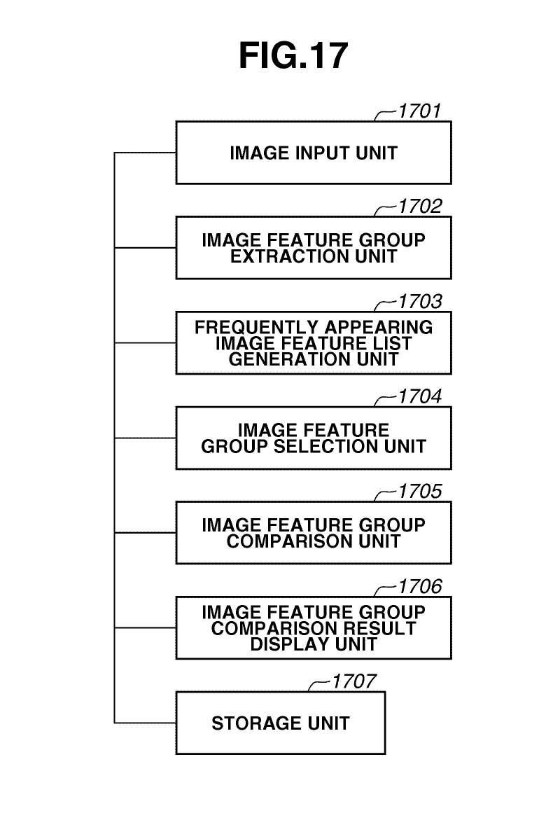

FIG. 17 is a block diagram illustrating a functional configuration example of an image retrieval apparatus according to the third exemplary embodiment. The operation of the components illustrated in FIG. 17 will be described in detail below.

In FIG. 17, an image input unit 1701 inputs registration images and a query image. An image features extraction unit 1702 extracts image features from the registration images and the query image input from the image input unit 1701. A frequently appearing image feature list generation unit 1703 generates a frequently appearing image feature list from image features calculated from a plurality of registration images. The frequently appearing image feature list includes image features that are considered to appear frequently and have a low discrimination capability. Image features selection unit 1704 selects image features having a high discrimination capability from the image features of the query image. Image features comparison unit 1705 performs image features comparison by using the image features of the query image selected by the image features selection unit 1704. Image features comparison result display unit 1706 displays image features comparison result of the image features comparison unit 1705. A storage unit 1707 is a memory or HDD that stores data in process. Such components are comprehensively controlled by a not-illustrated CPU.

The CPU can execute a program or programs to function as various units. An ASIC or other control circuits operating in cooperation with the CPU may function as such units. The CPU and a control circuit that controls the operation of an image processing apparatus may cooperate to implement such units. The CPU need not be a single one, and there may be a plurality of CPUs. In such a case, the plurality of CPUs may perform processing in a distributed manner. The plurality of CPUs may be arranged in one computer or in a plurality of physically different computers. The units implemented by the CPU(s) executing a program or programs may be implemented by a dedicated circuit or circuits.

### (Image Registration Processing)

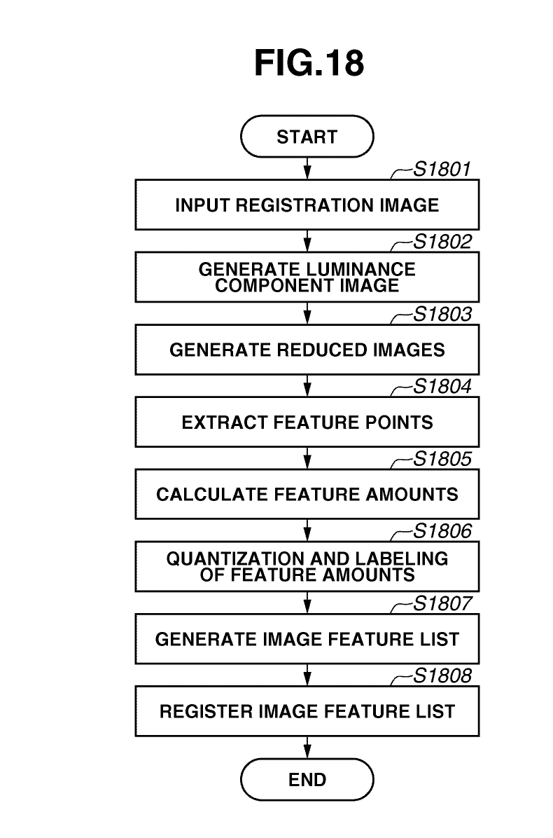

FIG. 18 is a flowchart illustrating an example of an image registration processing of the image retrieval apparatus according to the third exemplary embodiment. The flowchart is implemented by the CPU(s) executing a control program. In steps S1801 to S1808, the image retrieval apparatus performs similar processing to that of steps S201 to S208 in FIG. 2 according to the first exemplary embodiment.

### (Frequently Appearing Image Feature List Generation Processing)

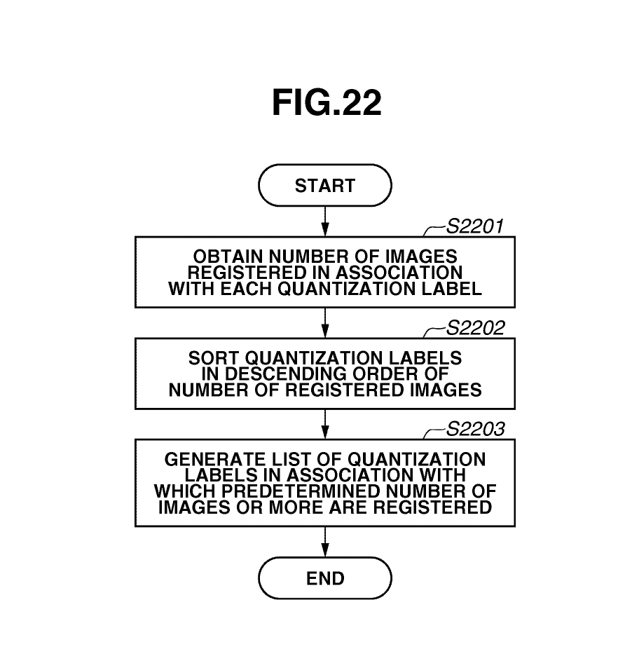

FIG. 22 is a flowcharting illustrating a frequently appearing image feature list generation processing of the frequently appearing image feature list generation unit 1703 of the image retrieval apparatus. The flowchart is implemented by the CPU(s) executing a control program. In the third exemplary embodiment, the frequently appearing image feature list generation unit 1703 generates a frequently appearing image feature list by using the number of images registered in association with each quantization label.

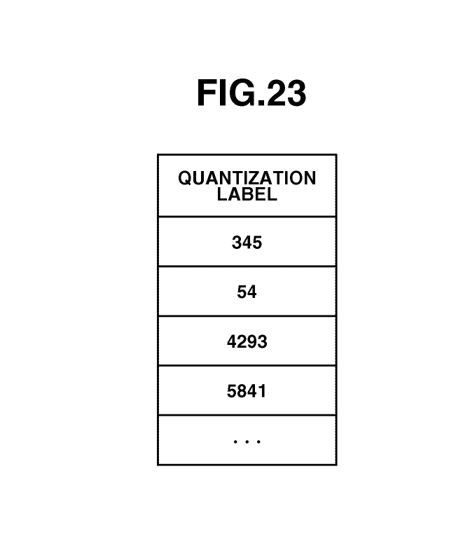

In step S2201, the frequently appearing image feature list generation unit 1703 obtains the number of images registered in association with each quantization label. In step S2202, the frequently appearing image feature list generation unit 1703 sorts the quantization labels in descending order of the number of registered images. In step S2203, the frequently appearing image feature list generation unit 1703 generates a list of quantization labels in association with which a predetermined number of images or more are registered, as a frequently appearing image feature list. FIG. 23 illustrates an example of the frequently appearing image feature list.

The predetermined number may be a fixed value given in advance. The predetermined number may be a variable value given as a ratio to the total number of registered images. If the predetermined number is given as a variable value according to the total number of registered images, the variable value may be determined in a fixed ratio to the total number of images. Alternatively, the variable value may be determined in a variable ratio to the total number of images. The predetermined number may be set to be a variable value until the total number of images reaches an upper limit, and the predetermined number may be a fixed value after the total number of images has reached the upper limit.

In the third exemplary embodiment, the frequently appearing image feature list generation unit 1703 sorts the quantization labels according to the numbers of registered images, and generates a frequently appearing image list by using the quantization labels in association with which a predetermined number of images or more are registered. Alternatively, the frequently appearing image feature list generation unit 1703 may sort the quantization labels according to the numbers of registered feature points or feature amounts, and generate a frequently appearing image list by using quantization labels in association with which a predetermined number of feature points or feature amounts or more are registered. In such a case, the predetermined number may be given as a fixed value in advance. Alternatively, the predetermined number may be given as a variable value according to the total number of registered feature points or feature amounts. If the variable value is given as a variable value according to the total number of registered feature points or feature amounts, the variable value may be determined in a fixed ratio to the total number of registered feature points or feature amounts. Alternatively, the variable value may be determined in a variable ratio to the total number of registered feature points or feature amounts. The frequently appearing image feature list generation unit 1703 may generate a frequently appearing image feature list at timing such as immediately after the image registration processing or when the image retrieval apparatus becomes idle after the image registration processing.

### (Image Retrieval Processing)

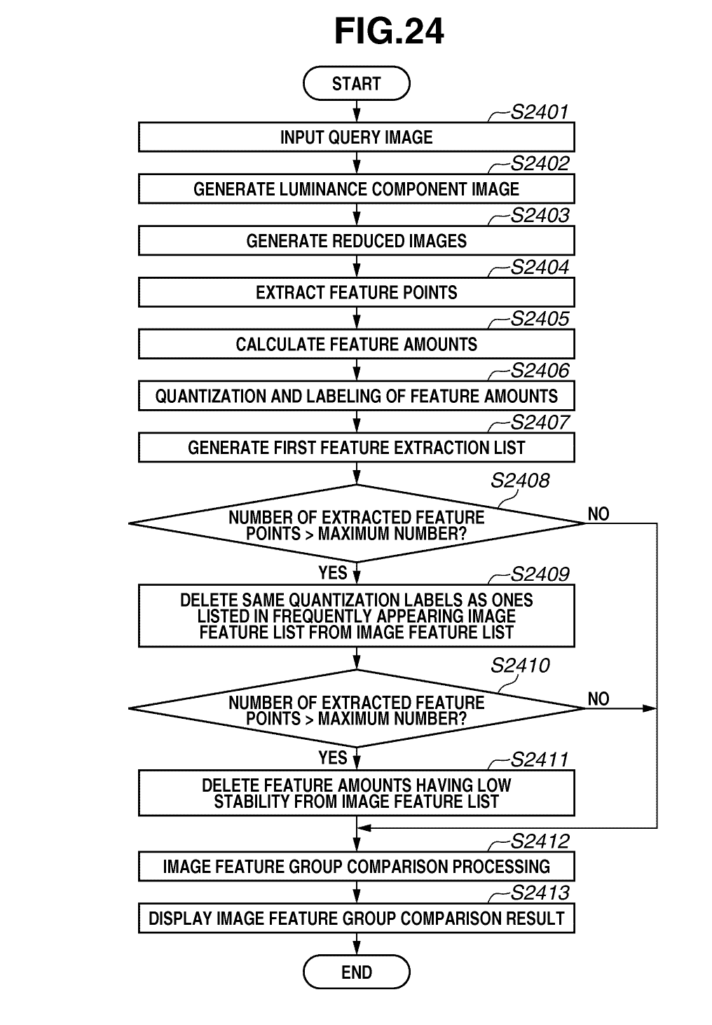

FIG. 24 is a flowchart illustrating an example of an image retrieval processing of the image retrieval apparatus according to the third exemplary embodiment. The flowchart is implemented by the CPU(s) executing a control program.

In step S2401, a query image is input via the image input unit 1701. The input image is stored in the storage unit 1707.

Next, the image features extraction unit 1702 performs the processing of steps S2402 to S2407. This processing is similar to the processing of steps S1802 to S1807 in the image registration processing. A detailed description thereof will be omitted.

In step S2408, if the number of feature points extracted from the query image is greater than the maximum number of feature points usable for a retrieval (YES in step S2408), the image features selection unit 1704 proceeds to step S2409. If the number of extracted feature points is less than or equal to the maximum number (NO in step S2408), the image features selection unit 1704 proceeds to step S2412.

In the third exemplary embodiment, the image features selection unit 1704 makes the determination based on whether the number of feature points of the query image is greater than the maximum number of feature points usable for a retrieval. However, the image features selection unit 1704 may make the determination based on whether the image feature list stored in the storage unit 1707 has a size (number of bytes) greater than the maximum size usable for a retrieval.

In step S2409, the image features selection unit 1704 deletes (excludes) the same quantization labels as the ones listed in the frequently appearing image feature list from the image feature list of the query image, thereby reducing the number of feature points of the query image. The image features selection unit 1704 may make the same quantization labels as the ones listed in the frequently appearing image feature list, identifiable on the image feature list of the query image, and restrict the use of such quantization labels in the processing of the image features comparison unit 1705.

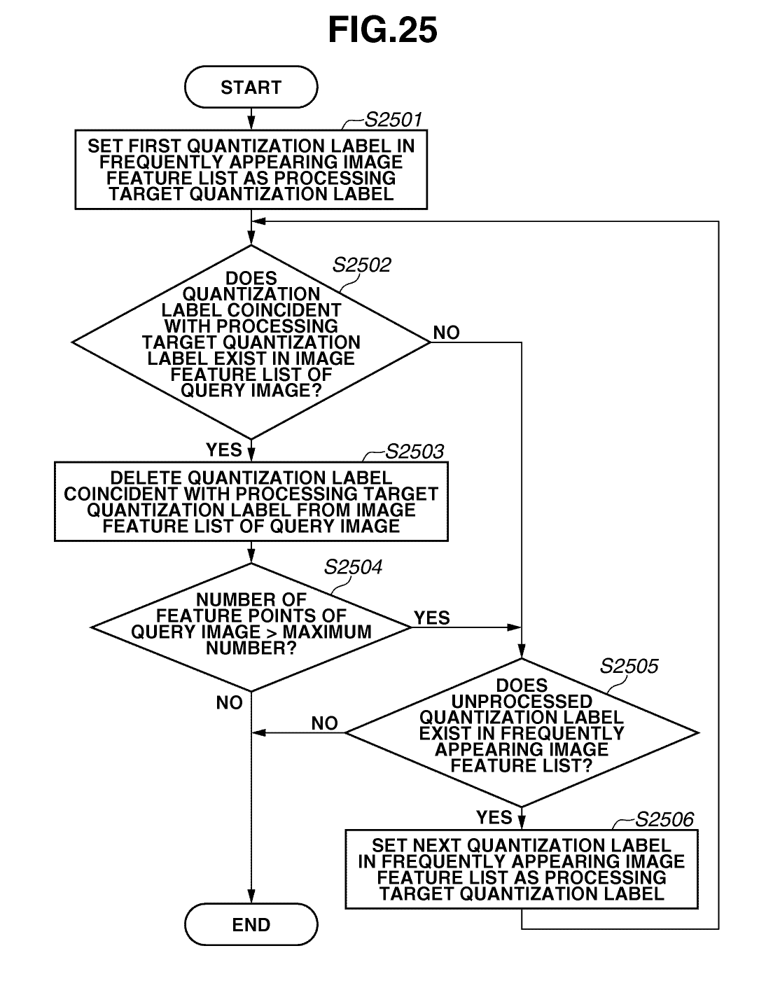

FIG. 25 is a flowchart illustrating an example of a frequently appearing image features reduction processing procedure in step S2409. The flowchart is implemented by the CPU(s) executing a control program.

In step S2501, the image features selection unit 1704 sets the first quantization label in the frequently appearing image feature list as a processing target quantization label. As described in step S2202, the frequently appearing image feature list is sorted in descending order of the number of registered images or the number of registered feature points or feature amounts. Accordingly, image features ranked higher in the frequently appearing image feature list have a larger registration number and have a lower discrimination capability. In the third exemplary embodiment, the image features selection unit 1704 therefore carries on reduction from image features ranked higher in the frequently appearing image feature list.

In step S2502, if a quantization label coincident with the processing target quantization label exists in the image feature list of the query image (YES in step S2502), the image features selection unit 1704 proceeds to step S2503. If not (NO in step S2502), the image features selection unit 1704 proceeds to step S2505.

In step S2503, the image features selection unit 1704 deletes the quantization label coincident with the processing target quantization label from the image feature list of the query image. The image features selection unit 1704 may make the quantization label coincident with the processing target quantization label, identifiable on the image feature list of the query image, and restrict the use of the quantization label in the processing of the image features comparison unit 1705.

In step S2504, if the number of feature points of the query image becomes greater than the maximum number of feature points usable for a retrieval (YES in step S2504), the image features selection unit 1704 proceeds to step S2505. If the number of feature points becomes less than or equal to the maximum number (NO in step S2504), the image features selection unit 1704 ends the frequently appearing image features reduction processing.

In the third exemplary embodiment, the image features selection unit 1704 makes the determination based on whether the number of feature points of the query image is greater than the maximum number of feature points usable for a retrieval. However, the image features selection unit 1704 may make the determination based on whether the image feature list stored in the storage unit 1707 has a size greater than the maximum size usable for a retrieval.

In step S2505, if an unprocessed quantization label exists in the frequently appearing image feature list (YES in step S2505), the image features selection unit 1704 proceeds to step S2506. If not (NO in step S2505), the image features selection unit 1704 ends the frequently appearing image features reduction processing.

In step S2506, the image features selection unit 1704 sets the next quantization label in the frequently appearing image feature list as the processing target quantization label. The image features selection unit 1704 returns to step S2502.

In the third exemplary embodiment, the image features selection unit 1704 performs the frequently appearing image features reduction processing only if the number of feature points extracted from the query image is greater than the maximum number of feature points usable for a retrieval. Such conditional branching may be omitted, and the image features selection unit 1704 may always perform the frequently appearing image features reduction processing. In step S2504, the image features selection unit 1704 continues the frequently appearing image features reduction processing only if the number of feature points of the query image is greater than the maximum number of feature points usable for a retrieval. Such conditional branching may be omitted, and the image image group selection unit 1704 may delete all the feature group listed in the frequently appearing image feature list from the image feature list of the query image. In the third exemplary embodiment, as described in step S2202, the frequently appearing image feature list is sorted by the number of registered images or the number of registered feature points or feature amounts. However, if the image features selection unit 1704 deletes all the feature group listed in the frequently appearing image feature list, the frequently appearing image feature list need not be sorted. In such a case, the processing of step S2202 may be omitted.

After the end of the frequently appearing image features reduction processing in step S2409, then in step S2410, if the number of feature points extracted from the query image is greater than the maximum number of feature points usable for a retrieval (YES in step S2410), the image features selection unit 1704 proceeds to step S2411. If the number of feature points is less than or equal to the maximum number (NO in step S2410), the image features selection unit 1704 proceeds to step S2412.

In the third exemplary embodiment, the image features selection unit 1704 makes the determination based on whether the number of feature points of the query image is greater than the maximum number of feature points usable for a retrieval. Like step S2408, the image features selection unit 1704 may make the determination based on whether the image feature list stored in the storage unit 1707 has a size greater than the maximum size usable for a retrieval.

In step S2411, the image features selection unit 1704 evaluates the stability of the feature amounts of the query image, and deletes feature amounts having low stability from the image feature list of the query image, thereby reducing the number of feature points in the query image. To reduce the number of feature points by utilizing the stability of the feature amounts of the query image, the image features selection unit 1704 can use the method discussed in Japanese Patent Application No. 2011-237962.

More specifically, the image features selection unit 1704 determines the positions of feature points and the feature-to-feature distances of feature amounts resulting from image processing such as rotation and reduction of the image to be analyzed, and uses the positions and the distances as stability indexes. The feature amounts clearly change if the positions of the feature points vary greatly. The image feature selection unit 104 therefore narrows feature points down to the ones falling within a given threshold range in position. The image feature selection unit 1704 then determines changes in the feature amounts, i.e., distances between the feature amounts before and after the image processing such as rotation and reduction, and use the distances as stability indexes. The greater the distance is, the lower the stability is considered to become. The image features selection unit 1704 sorts the feature amounts in descending order of the distance, and deletes feature amounts having low stability from the image feature list of the query image until the number of feature points falls to or below the maximum number of feature points usable for a retrieval.

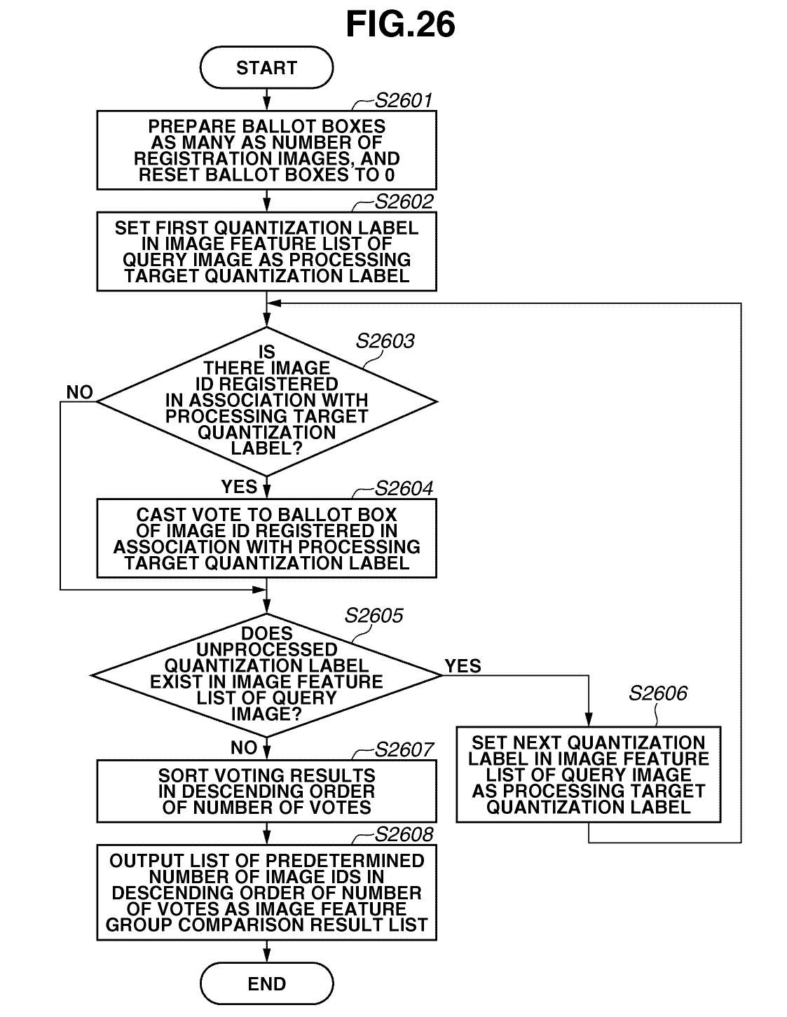

In step S2412, the image features comparison unit 1705 performs image features comparison processing. FIG. 26 is a flowchart illustrating an example of the image features comparison processing in step S2412. The flowchart is implemented by the CPU(s) executing a control program.

In step S2601, the image features comparison unit 1705 prepares ballot boxes as many as the number of registration images, and resets the ballot boxes to 0. In step S2602, the image features comparison unit 1705 sets the first quantization label in the image feature list of the query image as a processing target quantization label.

In step S2603, if there is an image ID registered in association with the processing target quantization label (YES in step S2603), the image features comparison unit 1705 proceeds to step S2604. If there is no such image ID (NO in step S2603), the image features comparison unit 1705 proceeds to step S2605. In step S2604, the image features comparison unit 1705 casts a vote to the ballot box of the image ID registered in association with the processing target quantization label.

In step S2605, if an unprocessed quantization label exists in the image feature list of the query image (YES in step S2605), the image features comparison unit 1705 proceeds to step S2606. If not (NO in step S2605), the image features comparison unit 1705 proceeds to step S2607.

In step S2606, the image features comparison unit 1705 sets the next quantization label in the image feature list of the query image as the processing target quantization label. The image features comparison unit 1705 returns to step S2603.

In step S2607, the image features comparison unit 1705 sorts the voting results in descending order of the number of votes. In step S2608, the image features comparison unit 1705 outputs a list including a predetermined number of image IDs in descending order of the number of votes as image features comparison result list.

In the third exemplary embodiment, the image features comparison unit 1705 performs the image features comparison by comparing the registered quantization labels and the quantization labels of the query image. However, the comparison is not limited to such a method. The image features comparison unit 1705 may perform the image features comparison by comparing the feature amounts themselves or by comparing the coordinates of the feature points.

In step S2413, the image features comparison result display unit 1706 displays the image features comparison result. To display the image features comparison result, the image features comparison result display unit 1706 displays both the image IDs and the corresponding images.

Whether local feature amounts having a high discrimination capability, or stable local feature amounts robust to rotation and scaling is preferentially used for a retrieval, depends on the retrieval target image.

For example, suppose that the retrieval target image is an image including only textures or the background such as the sky, trees, and the ground. Such an image is less suitable for a retrieval preferentially using local feature amounts having a high discrimination capability. The reason is that most of the image features are considered to have a low discrimination capability and not much difference therebetween.

On the other hand, if the retrieval target image is an ordinary image including an object and the background, such an image is suitable for a retrieval preferentially using local feature amounts having a high discrimination capability. The reason is that if image features having a low discrimination capability is appropriately excluded, image features having a high discrimination capability mainly extracted from the object(s) are used for a retrieval.

Then, depending on the retrieval target image, the image features selection unit 1704 may change the order of steps S2409 and S2411 so that unstable local feature amounts are excluded first. If the number of local feature mounts still exceeds the maximum number, the image features selection unit 1704 may exclude local feature amounts having a low discrimination capability.

Not depending on the retrieval target image, a sequence of steps S2409 and S2411 may be switched to make the number of image features appropriate and/or to change a preferential order and compare retrieval results which vary between when local feature amounts having a high discrimination capability has a higher priority, and when stable local feature amounts robust to rotation and scaling has a higher priority.

As described above, in the third exemplary embodiment, the image retrieval apparatus selects image features by excluding image features having a low discrimination capability from the image features extracted from the query image. The image retrieval apparatus then performs a retrieval by using the selected image features. Consequently, even if the number of feature points usable for a retrieval is limited, the retrieval can be performed with deterioration reduced in the retrieval accuracy.

A fourth exemplary embodiment of the present invention will be described below with reference to the drawings. The fourth exemplary embodiment deals with an example of an image retrieval system. In the image retrieval system, an image retrieval client (image retrieval terminal) captures an image to generate a query image and extracts image features. The image retrieval client transmits the image features to an image retrieval server. The image retrieval server performs a retrieval inside. The retrieval result is displayed on the image retrieval client. The image retrieval client is a query image providing apparatus for providing a query image. Image registration processing in the image retrieval server is performed by a similar method to that of the third exemplary embodiment.

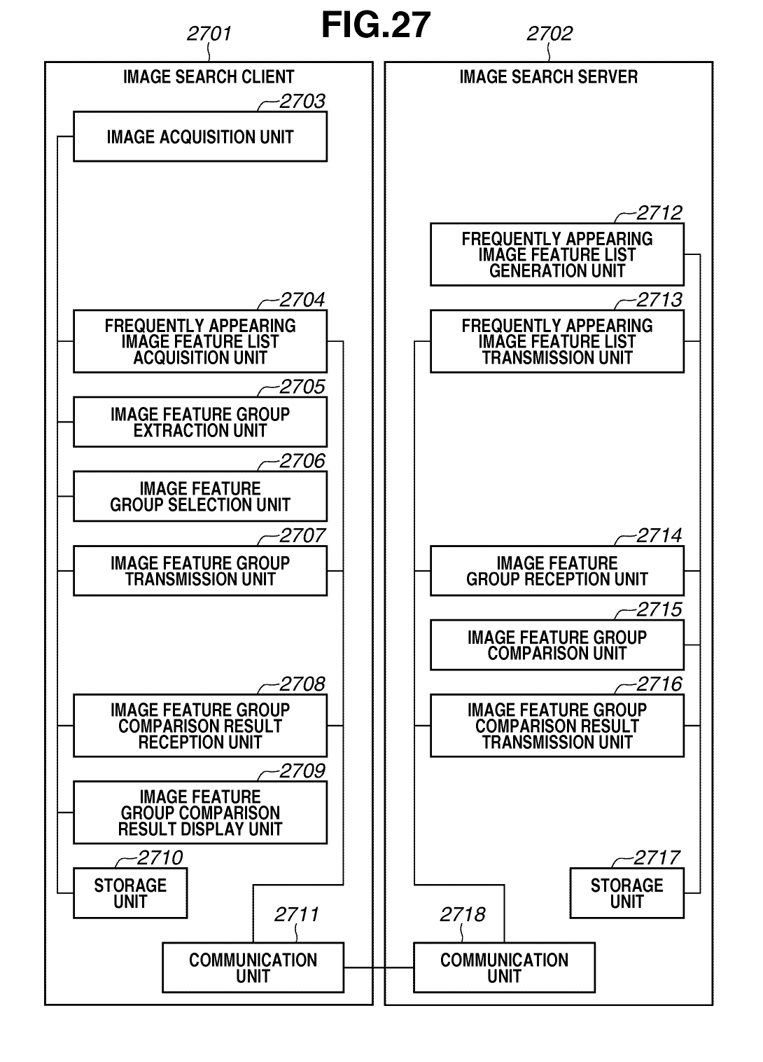

FIG. 27 is a block diagram illustrating a functional configuration example of the image retrieval system according to the fourth exemplary embodiment. The operation of the components illustrated in FIG. 27 will be described in detail below.

The image retrieval system illustrated in FIG. 27 includes an image retrieval client 2701 and an image retrieval server 2702. The image retrieval client 2701 and the image retrieval server 2702 include communication units 2711 and 2718, respectively. The communication units 2711 and 2718 are connected to each other by a network (wired or wireless), and perform information communication via the network.

In the image retrieval client 2701, an image acquisition unit 2703 obtains a query image by photographing with a camera. A frequently appearing image feature list acquisition unit 2704 requests of the image retrieval server 2702 a frequently appearing image feature list generated by the image retrieval server 2702, and obtains the frequently appearing image feature list via the communication unit 2711. Image features extraction unit 2705 extracts image features from the query image obtained by the image acquisition unit 2703. Image features selection unit 2706 selects image features having a high discrimination capability from the image features of the query image. Image features transmission unit 2707 transmits the image features selected by the image features selection unit 2706 to the image retrieval server 2702 via the communication unit 2711. Image features comparison result reception unit 2708 receives a result of image features comparison performed by the image retrieval server 2702 via the communication unit 2711. Image features comparison result display unit 2709 displays the result of the image features comparison obtained by the image features comparison result reception unit 2708. A storage unit 2710 is a memory or HDD which stores data being processed in the image retrieval client 2701.

In the image retrieval server 2702, a frequently appearing image feature list generation unit 2712 generates an image feature list (frequently appearing image feature list) that includes image features having high frequencies of appearance and a low discrimination capability from Image features calculated from a plurality of registration images. A frequently appearing image feature list transmission unit 2713 transmits a frequently appearing image feature list generated by the frequently appearing image feature list generation unit 2712 to the image retrieval client 2701 via the communication unit 2718 in response to a request from the image retrieval client 2701. Image features reception unit 2714 receives the image features of the query image calculated and selected by the image retrieval client 2701 via the communication unit 2718. Image features comparison unit 2715 performs image features comparison by using the image features of the query image received by the image features reception unit 2714. Image features comparison result transmission unit 2716 transmits the result of the image features comparison performed by the image features comparison unit 2715 to the image retrieval client 2701 via the communication unit 2718. A storage unit 2717 is a memory or HDD which stores data being processed in the image retrieval server 2702.

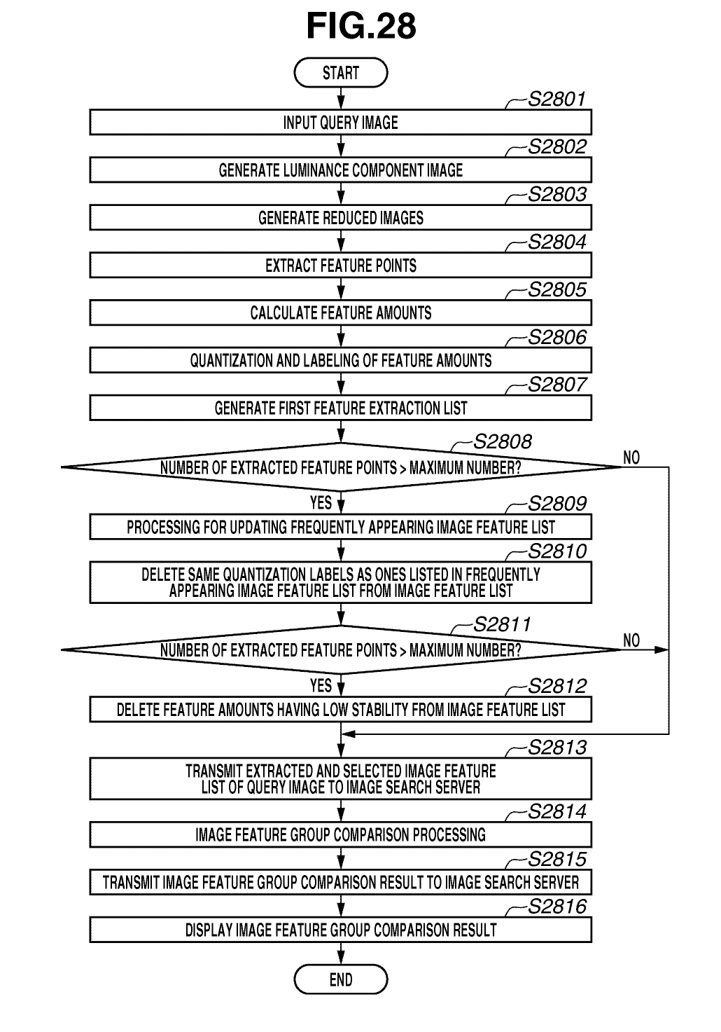

The image features selection unit 2706 may be provided on the image retrieval server 2702 side. In such a case, the image features transmission unit 2707 transmits the image features of the query image extracted by the image features extraction unit 2705 to the image retrieval server 2702 via the communication unit 2711. The image features selection unit 2706 in the image retrieval server 2702 selects image features having a high discrimination capability from the image features of the query image. The image features comparison unit 2715 performs image features comparison by using the image features selected by the image features selection unit 2706 on the image retrieval server 2702 side. Also in the flowchart of an image retrieval processing procedure illustrated in FIG. 28, the image features selection unit 2706 performs its processing on the image retrieval server 2702 side.

Such components are comprehensively controlled by a not-illustrated CPU.

The CPU can execute a program or programs to function as various units. An ASIC or other control circuits operating in cooperation with the CPU may function as such units. The CPU and a control circuit that controls the operation of an image processing apparatus may cooperate to implement such units. The CPU need not be a single one, and there may be a plurality of CPUs. In such a case, the plurality of CPUs may perform processing in a distributed manner. The plurality of CPUs may be arranged in one computer or in a plurality of physically different computers. The units implemented by the CPU(s) executing a program or programs may be implemented by a dedicated circuit or circuits.

### (Frequently Appearing Image Feature List Generation Processing)

Frequently appearing image feature list generation processing of the frequently appearing image feature list generation unit 2712 in the image retrieval server 2702 of the image retrieval system according to the fourth exemplary embodiment is similar to the frequently appearing image feature list generation processing according to the third exemplary embodiment. A detailed description thereof will be omitted.

The frequently appearing image feature list generation unit 2712 stores the frequently appearing image feature list together with the generation date and time or version information about the frequently appearing image feature list so that old and new updates can be checked.

Like the third exemplary embodiment, the frequently appearing image feature list generation unit 2712 may generate a frequently appearing image feature list at timing such as immediately after image registration processing or when the image retrieval server 2702 becomes idle after the image registration processing.

### (Image Retrieval Processing)

FIG. 28 is a flowchart illustrating an example of an image retrieval processing procedure of the image retrieval system according to the fourth exemplary embodiment. The flowchart is implemented by the CPU(s) executing a control program.

In step S2801, the image retrieval client 2701 obtains a query image via the image acquisition unit 2703 by photographing with a camera. The obtained image is stored in the storage unit 2710.

Next, the image features extraction unit 2705 performs the processing of steps S2802 to S2807. This processing is similar to the processing of steps S1802 to S1807 in the image registration processing according to the third exemplary embodiment or that of steps S2402 to S2407 in the image retrieval processing according to the third exemplary embodiment. A detailed description thereof will be omitted.

In step S2808, if the number of feature points extracted from the query image is greater than the maximum number of feature images usable for a retrieval (YES in step S2808), the image retrieval client 2701 proceeds to step S2809. If the number of extracted feature points is less than or equal to the maximum number (NO in step S2808), the image retrieval client 2701 proceeds to step S2813.

In the fourth exemplary embodiment, the image retrieval client 2701 makes the determination based on whether the number of feature points of the query image is greater than the maximum number of feature points usable for a retrieval. However, the image retrieval client 2701 may make the determination based on whether the image feature list stored in the storage unit 2710 has a size greater than the maximum size usable for a retrieval.

In step S2809, the image retrieval client 2701 performs processing for updating the frequently appearing image feature list.

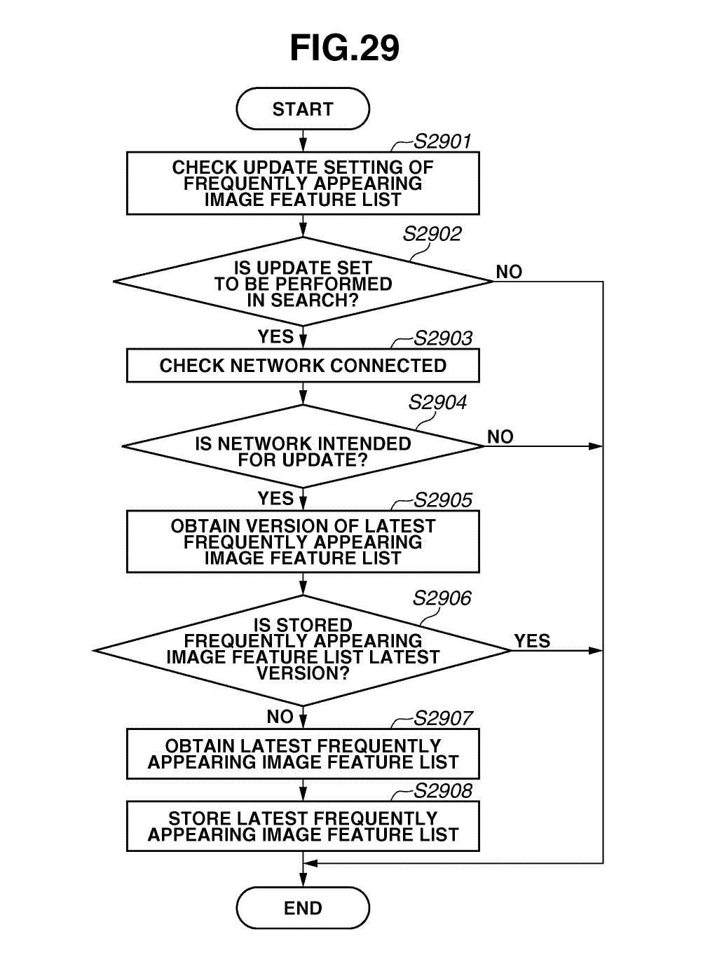

FIG. 29 is a flowchart illustrating an example of the processing for updating the frequently appearing image feature list. This flowchart is implemented by the CPU(s) executing a control program.

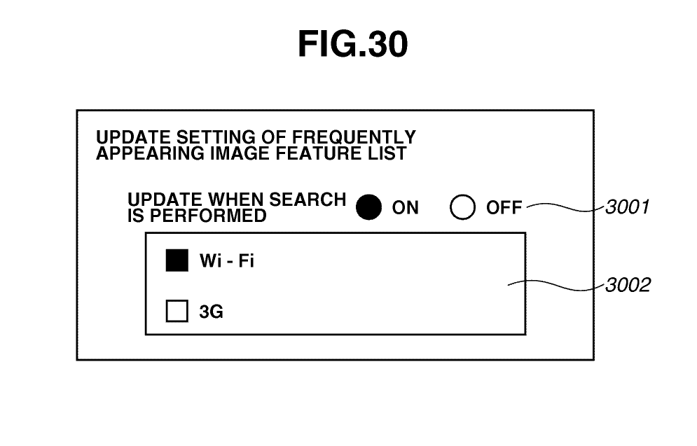

In step S2901, the image retrieval client 2701 checks an update setting of the frequently appearing image feature list. The update setting of the frequently appearing image feature list sets whether to perform an update at the time of retrieval. If an update is set to be performed at the time of a retrieval, the update setting further sets network connection in which the update is carried out. FIG. 30 illustrates an example of a user interface for making the update setting of the frequently appearing image feature list. In FIG. 30, buttons 3001 set whether to perform an update at the time of a retrieval. Buttons 3002 determine which network connection to use in performing the update.

In step S2902, if an update is set to be performed at the time of a retrieval (YES in step S2902), the image retrieval client 2701 proceeds to step S2903. If an update is set not to be performed (NO in step S2902), the image retrieval client 2701 ends the processing for updating the frequently appearing image feature list.

In step S2903, the image retrieval client 2701 checks the connected network. In step S2904, if the network is intended for update (YES in step S2904), the image retrieval client 2701 proceeds to step S2905. If the network is not intended for update (NO in step S2904), the image retrieval client 2701 ends the processing for updating the frequently appearing image feature list.

In step S2905, the image retrieval client 2701 obtains the version of the latest frequently appearing image feature list from the image retrieval server 2702 via the communication unit 2711. In step S2906, if the frequently appearing image feature list stored in the image retrieval client 2701 is not the latest version (NO in step S2906), the image retrieval client 2701 proceeds to step S2907. If the retained frequently appearing image feature list is the latest version (YES in step S2906), the image retrieval client 2701 ends the processing for updating the frequently appearing image feature list.

In step S2907, the frequently appearing image feature list acquisition unit 2704 obtains the latest frequently appearing image feature list from the image retrieval server 2702 via the communication unit 2711. In step S2908, the image retrieval client 2701 stores the latest frequently appearing image feature list received in step S2907, and ends the processing for updating the frequently appearing image feature list.

In the fourth exemplary embodiment, the image retrieval client 2701 updates the frequently appearing image feature list at the time of retrieval. Alternatively, the image retrieval client 2701 may independently perform only the processing for updating the frequently appearing image feature list. In such a case, it becomes possible that the image retrieval client 2701 updates the frequently appearing image list when a Wireless Fidelity (Wi-Fi) connection is made at home before going out for a trip. Accordingly, network traffic can be reduced away from home.

After the end of the processing for updating the frequently appearing image feature list in step S2809, then in step S2810 to S2812, the image retrieval client 2701 performs processing for reducing the image feature list. This processing is similar to the processing of steps S2409 to S2411 in the image retrieval processing according to the third exemplary embodiment. A detailed description thereof will be omitted.

In step S2813, the image retrieval client 2701 transmits the extracted and selected image feature list of the query image to the image retrieval server 2702 via the communication unit 2711.

In step S2814, the image retrieval server 2702 performs image features comparison processing. This processing is similar to the processing of step S2412 in the image retrieval processing according to the third exemplary embodiment. A detailed description thereof will be omitted. In step S2815, the image retrieval server 2702 transmits the image features comparison result obtained in step S2814 to the image retrieval client 2701 via the communication unit 2718.

In step S2816, the image retrieval client 2701 displays the image features comparison result. This processing is similar to that of step S2413 in the image retrieval processing according to the third exemplary embodiment.

As described above, in the fourth exemplary embodiment, the image retrieval client 2701 selects Image features from the image features extracted from the query image, and transmits the selected image features to the image retrieval server 2702. The image retrieval server 2702 then performs a retrieval. This allows the image retrieval server 2702 to perform the retrieval with deterioration reduced in the retrieval accuracy even if the number of feature points usable for a retrieval is limited.

A fifth exemplary embodiment of the present invention will be described below with reference to the drawings. The fifth exemplary embodiment deals with an example of an image retrieval apparatus that extracts image features from a query image, performs a retrieval by using the resulting image features, and displays a retrieval result. In the fifth exemplary embodiment, the image retrieval apparatus performs a retrieval by using preferentially a differential image features and using a frequently appearing image features as little as possible. The image retrieval system performs image registration processing by a similar method to that of first exemplary embodiment.

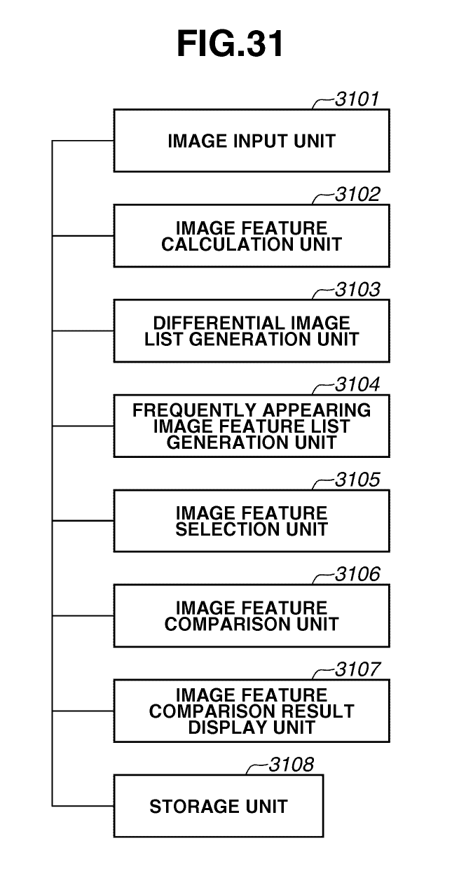

FIG. 31 is a block diagram illustrating a functional configuration example of the image retrieval apparatus according to the present exemplary embodiment. The operation of the components illustrated in FIG. 31 will be described in detail below.

An image input unit 3101, an image feature calculation unit 3102, and a differential image feature list generation unit 3103 illustrated in FIG. 31 are similar to the image input unit 101, the image feature calculation unit 102, and the differential image feature list generation unit 103 illustrated in FIG. 1, respectively. A frequently appearing image feature list generation unit 3104 illustrated in FIG. 31 is similar to the frequently appearing image feature list generation unit 1703 illustrated in FIG. 17.

An image feature selection unit 3105 selects Image features having a high discrimination capability by reducing frequently appearing image features other than differential image features in an image feature list of a query image.

An image feature comparison unit 3106, an image feature comparison result display unit 3107, and a storage unit 3108 illustrated in FIG. 31 are similar to the image feature comparison unit 105, the image feature comparison result display unit 106, and the storage unit 107 illustrated in FIG. 1, respectively.

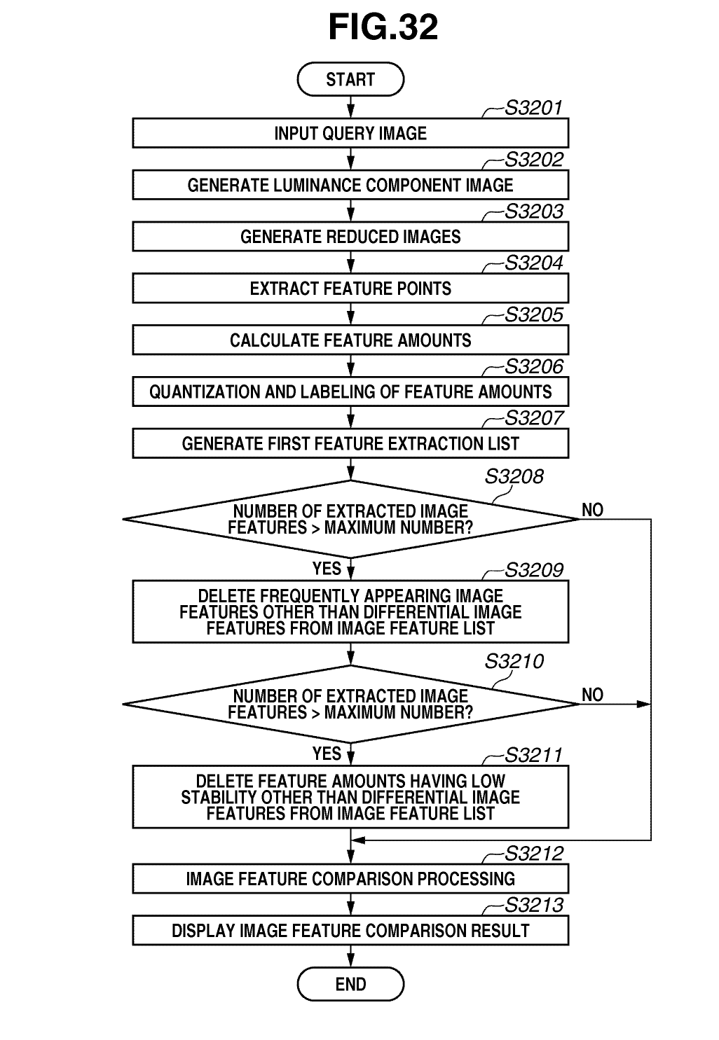

FIG. 32 is a flowchart illustrating an example of an image retrieval processing procedure of the image retrieval apparatus according to the fifth exemplary embodiment. The flowchart is implemented by a CPU(s) executing a control program.

Steps S3201 to S3207 are similar to steps S801 to S807 illustrated in FIG. 8 according to the first exemplary embodiment. A detailed description thereof will be omitted.

In step S3208, if the number of image features extracted from the query image is greater than the number of image features usable for a retrieval (YES in step S3208), the image retrieval apparatus proceeds to step S3209. If the number of extracted image features is less than or equal to the maximum number (NO in step S3208), the image retrieval apparatus proceeds to step S3212.

In step S3209, the image retrieval apparatus reduces frequently appearing image features other than differential image features in the image feature list of the query image. Some image features that typically have a low discrimination capability may have a high discrimination capability under a certain condition. Such image features are included in both the differential image feature list and the frequently appearing image feature list. In the fifth exemplary embodiment, to use such image features for a retrieval, the image retrieval apparatus will not delete frequently appearing image features included in the differential image feature list, but leave such image features in the image feature list of the query image. This processing may be performed by generating a second feature extraction list and adding image features having a high discrimination capability and quantization labels not listed in the frequently appearing image feature list to the second feature extraction list.

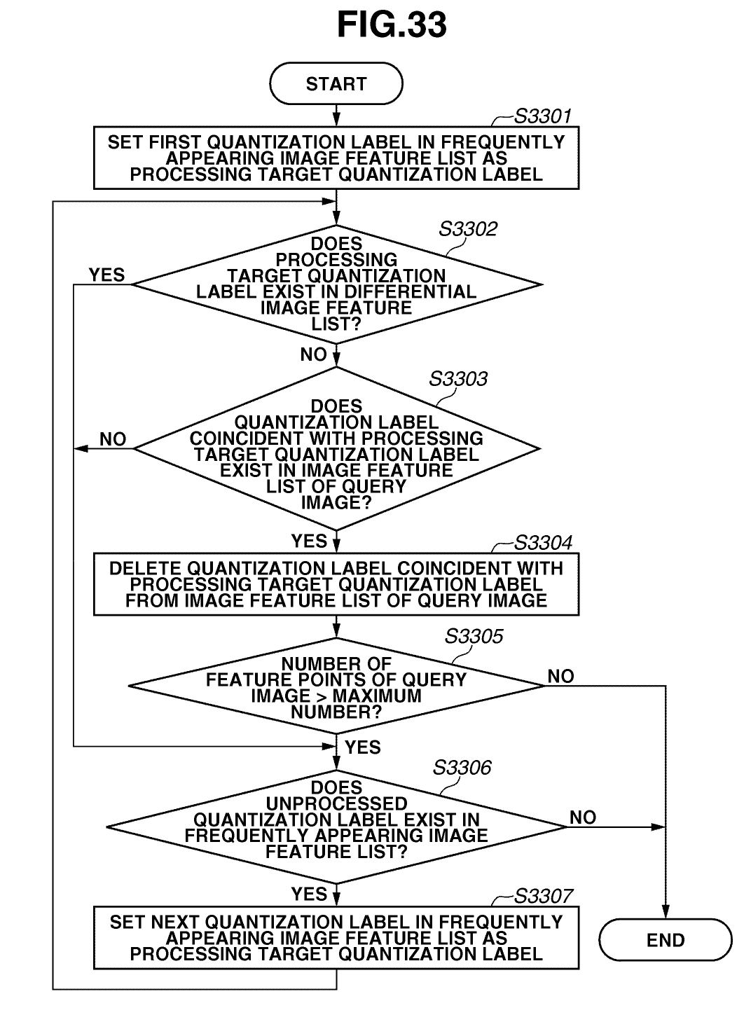

FIG. 33 is a flowchart illustrating an example of the processing for reducing frequently appearing image features other than differential image features in the image feature list in step S3209. The flowchart is implemented by the CPU(s) executing a control program. This processing is performed by the image feature selection unit 3105.

In step S3301, the image feature selection unit 3105 sets the first quantization label in the frequently appearing image feature list as a processing target quantization label. In step S3302, if the processing target quantization label does not exist in the differential image feature list (NO in step S3302), the image feature selection unit 3105 proceeds to step S3303. If the processing target quantization label exists in the differential image feature list (YES in step S3302), the image feature selection unit 3105 proceeds to step S3306. In step S3303, if the processing target quantization label exists in the image feature list of the query image (YES in step S3303), the image feature selection unit 3105 proceeds to step S3304. If not (NO in step S3303), the image feature selection unit 3105 proceeds to step S3306.

In step S3304, the image feature selection unit 3105 deletes the quantization label coincident with the processing target quantization label from the image feature list of the query image. In step S3305, if the number of feature points of the query image is greater than the maximum number of feature points usable for a retrieval (YES in step S3305), the image feature selection unit 3105 proceeds to step S3306. If the number of feature points is less than or equal to the maximum number (NO in step S3305), the image feature selection unit 3105 ends the processing.

In step S3306, if an unprocessed quantization label exists in the frequently appearing image feature list (YES in step S3307), the image feature selection unit 3105 proceeds to step S3307. If not (NO in step S3307), the image feature selection unit 3105 ends the processing.

In step S3307, the image feature selection unit 3105 sets the next quantization label in the frequently appearing image feature list as the processing target quantization label. The image feature selection unit 3105 returns to step S3302.

After the end of the processing of step S3209, then in step S3210, if the number of image features extracted from the query image is greater than the number of image features usable for a retrieval (YES in step S3210), the image retrieval apparatus proceeds to step S3211. If the number of extracted image features is less than or equal to the maximum number (NO in step S3210), the image retrieval apparatus proceeds to step S3212.

In step S3211, the image retrieval apparatus evaluates the stability of the feature amounts of the query image, and deletes feature amounts having low stability other than differential image features from the image feature list of the query image, thereby reducing the number of feature points of the query image. The method for reducing the number number of features by using the stability of the feature points of the query image is similar to the processing of step S2411. A detailed description thereof will be omitted.

Steps S3212 and S3213 are similar to steps S815 and S816. A detailed description thereof will be omitted.

As described above, in the fifth exemplary embodiment, the image retrieval apparatus preferentially adopts highly-differentiable image features of the differential image feature list, which describes image features unique to landmarks using GPS information, among the image features extracted from the query image. The image retrieval apparatus further excludes image features having a low discrimination capability from the image features extracted from the query image. This can narrow feature amounts down to the ones having a high discrimination capability. The image retrieval apparatus then performs a retrieval by using the selected image features. Consequently, even if the number of feature points usable for a retrieval is limited, the retrieval can be performed with deterioration reduced in the retrieval accuracy.

A sixth exemplary embodiment of the present invention will be described below with reference to the drawings. The sixth exemplary embodiment deals with an example of an image retrieval system. In the image retrieval system, a retrieval client (request source) serving as an image retrieval terminal captures an image to generate a query image, and extracts image features. The retrieval client transmits the image features to an image retrieval server. The image retrieval server performs a retrieval in the server. The retrieval result is displayed on the retrieval client. The retrieval client is a query image providing apparatus. In the sixth exemplary embodiment, the image retrieval server performs a retrieval by using preferentially a differential image features and using a frequently appearing image features as little as possible. Image registration processing for the image retrieval server is performed by a similar method to that of the first exemplary embodiment.

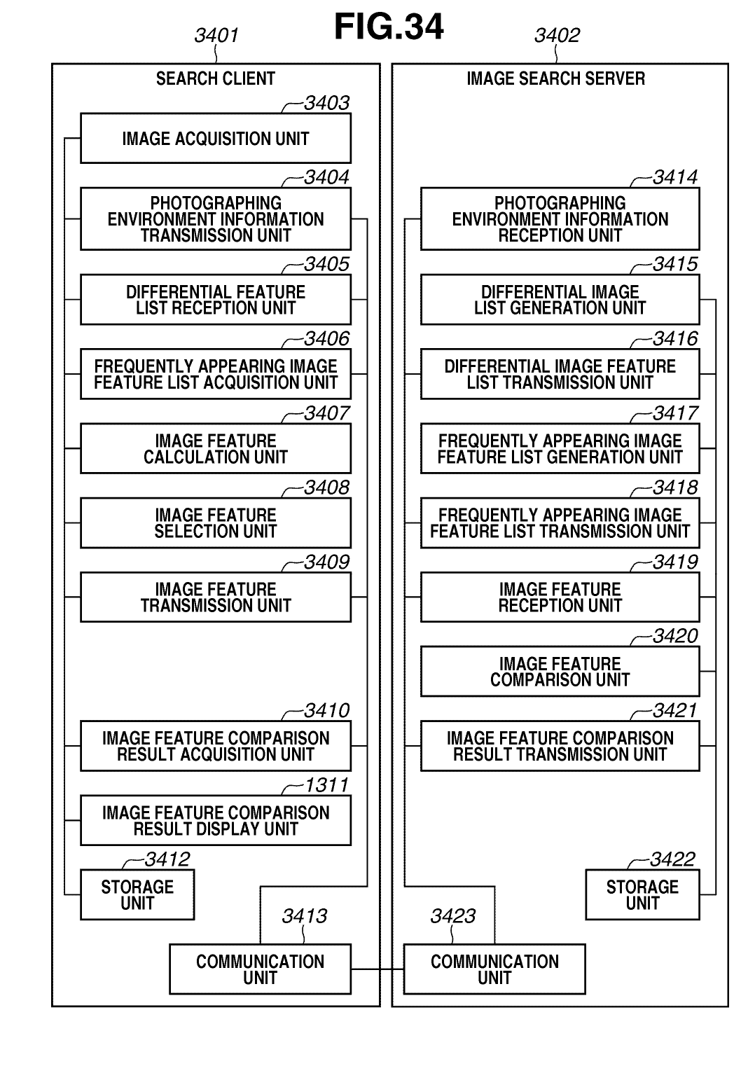

FIG. 34 is a block diagram illustrating a functional configuration example of the image retrieval system according to the present exemplary embodiment. The operation of the components illustrated in FIG. 34 will be described in detail below.

Like the second exemplary embodiment, the image retrieval system illustrated in FIG. 34 includes a retrieval client 3401 and an image retrieval server 3402. The retrieval client 3401 and the image retrieval server 3402 include communication units 3413 and 3423, respectively. The communication units 3413 and 3423 are connected to each other by a network (wired or wireless), and perform information communication via the network.

In the retrieval client 3401, an image acquisition unit 3403, a photographing environment information transmission unit 3404, a differential image feature list reception unit 3405, an image feature calculation unit 3407, an image feature selection unit 3408, an image feature transmission unit 3409, an image feature comparison result acquisition unit 3410, an image feature comparison result display unit 3411, a storage unit 3412, and the communication unit 3413 are similar to the image acquisition unit 1103, the photographing environment information transmission unit 1104, the differential image feature list reception unit 1105, the image feature calculation unit 1106, the image feature selection unit 1107, the image feature transmission unit 1108, the image feature comparison result acquisition unit 1109, the image feature comparison result display unit 1110, the storage unit 1111, and the communication unit 1112 illustrated in FIG. 11, respectively. A frequently appearing image feature list reception unit 3406 is similar to the frequently appearing image feature list acquisition unit 2704 illustrated in FIG. 27.

In the image retrieval server 3402, a photographing environment information reception unit 3414, a differential image feature list generation unit 3415, a differential image feature list transmission unit 3416, an image feature reception unit 3419, an image feature comparison unit 3420, an image feature comparison result transmission unit 3421, a storage unit 3422, and the communication unit 3423 are similar to the photographing environment information reception unit 1113, the differential image feature list generation unit 1114, the differential image feature list transmission unit 1115, the image feature reception unit 1116, the image feature comparison unit 1117, the image feature comparison result transmission unit 1118, the storage unit 1119, and the communication unit 1120 illustrated in FIG. 11, respectively. A frequently appearing image feature list generation unit 3417 and a frequently appearing image feature list transmission unit 3418 are similar to the frequently appearing image feature list generation unit 2712 and the frequently appearing image feature list transmission unit 2713 illustrated in FIG. 27, respectively.

### (Image Retrieval Processing)

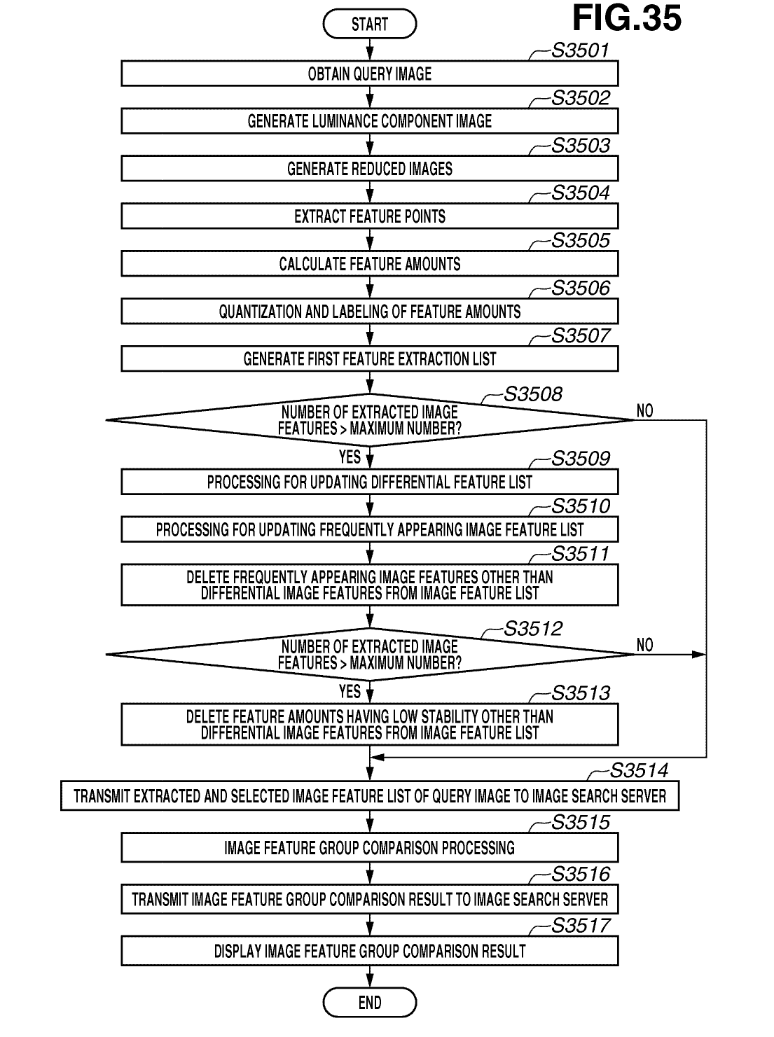

FIG. 35 is a flowchart illustrating an example of an image retrieval processing of the image retrieval system according to the sixth exemplary embodiment. The flowchart is implemented by a CPU(s) executing a control program.

Steps S3501 to S3507 are similar to steps S1201 to S1207 of FIG. 12 according to the second exemplary embodiment. A detailed description thereof will be omitted.

In step S3508, if the number of image features extracted from the query image is greater than the maximum number of image features usable for a retrieval (YES in step S3508), the retrieval client 3401 proceeds to step S3509. If the number of extracted image features is less than or equal to the maximum number (NO in step S3508), the retrieval client 3401 proceeds to step S3514.

In step S3509, the retrieval client 3401 performs processing for updating the differential image feature list. This processing is similar to step S1209 of FIG. 12 according to the second exemplary embodiment. A detailed description thereof will be omitted.

In step S3510, the retrieval client 3401 performs processing for updating the frequently appearing image feature list. This processing is similar to step S2809 of FIG. 28 according to the fourth exemplary embodiment. A detailed description thereof will be omitted.

Steps S3511 to S3513 are similar to steps S3209 to S3211 of FIG. 32 according to the fifth exemplary embodiment. A detailed description thereof will be omitted.

Steps S3514 to S3517 are similar to steps S1213 to S1219 of FIG. 12 according to the second exemplary embodiment. A detailed description thereof will be omitted.

As described above, according to the sixth exemplary embodiment, the retrieval client 3401 preferentially employs highly-differentiable image features of the differential image feature list, which describes image features unique to landmarks using GPS information, among the image features extracted from the query image. The retrieval client 3401 further excludes image features having a low discrimination capability from the image features extracted from the query image. This can narrow feature amounts down to the ones having a high discrimination capability. The retrieval client 3401 transmits the selected image features to the image retrieval server 3402, and the image retrieval server 3402 performs a retrieval. Consequently, even if the number of feature points usable for a retrieval is limited, the image retrieval server 3402 can perform the retrieval with deterioration reduced in the retrieval accuracy.

According to an exemplary embodiment of the present invention, local feature points and local feature amounts that have a high discrimination capability against other images and are significant for a retrieval can be obtained.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2013-001080, filed Jan. 8, 2013, and No. 2013-001086, filed Jan. 8, 2013 which are, hereby incorporated by reference herein in their entirety.

What is claimed is:

1. An image retrieval apparatus comprising:
a storage unit configured to store image features extracted from an input image and the image in association with each other;
a generation unit configured to generate a frequently appearing image feature list collecting image features including similar image features stored in the storage unit which are greater than a predetermined number;
a selection unit configured to select image features to be used as image features of a inputted query image, from image features extracted from the query image, based on the image features included in the frequently appearing image feature list; and
a comparison unit configured to compare image features selected to be used as the image features of the query image with image features of registered images stored in the storage unit.

2. The image retrieval apparatus according to claim 1, wherein a size or the number of image features of the query image to be used in the comparison unit is determined in advance.

3. The image retrieval apparatus according to claim 1, wherein the generation unit is configured to use a fixed value as the predetermined number.

4. The image retrieval apparatus according to claim 1, wherein the generation unit is configured to use a variable value as the predetermined number, the variable value being determined according to the number of image features stored in the storage unit or the number of images stored in the storage unit in association with the image features.

5. The image retrieval apparatus according to claim 1, wherein the generation unit is configured to determine as the predetermined number, a variable value or a fixed value, according to the total number of images stored in the storage unit in association with the image features.

6. The image retrieval apparatus according to claim 1, wherein the image features includes local feature points obtained by applying a Harris operator and local feature amounts corresponding to the local feature points.

7. The image retrieval apparatus according to claim 1, wherein the selection unit is configured to select the image features by excluding all or part of image features matching the image features included in the frequently appearing image feature list, from the image features of the query image.

8. The image retrieval apparatus according to claim 1, wherein the selection unit is configured to select the image feature by being identifiable all or part of image features matching the image features included in the frequently appearing image feature list in the image features of the query image; and
the comparison unit is configured to compare using the image features except for the image features been identifiable.

9. The image retrieval apparatus according to claim 1, wherein the selection unit is configured to select the image features of the query image based on a size or the number of image features of the query image determined in advance to be used in the comparison unit.

10. An image retrieval apparatus comprising:
a storage unit configured to store image features corresponding to an image;
a generation unit configured to generate a frequently appearing image feature list collecting image features in which the number of image features stored in the storage unit or the number of images stored in the storage unit in association with the image features is greater than a predetermined number;
a transmission unit configured to transmit the frequently appearing image feature list to a request source in response to a request;
a reception unit configured to receive image features selected by the request source as image features to be used as image features of a query image, based on the image features included in the frequently appearing image feature list; and
a comparison unit configured to compare the received image features of the query image with the image features stored in the storage unit.

11. A query image providing apparatus comprising:
an input unit configured to input a query image;
an extraction unit configured to extract image features of the query image;
a reception unit configured to receive a frequently appearing image feature list from an image retrieval apparatus;
a selection unit configured to select image features to be used as image features of the query image and image features not to be used, from among the image features of the query image, based on image features included in the frequently appearing image feature list; and
a transmission unit configured to transmit image features selected to be used as the image features of the query image, to the image retrieval apparatus.

12. An image retrieval apparatus comprising:
a storage unit configured to store image features extracted from an input image, attribute information about photographing obtained from the input image, and the image in association with each other;
a generation unit configured to generate with respect to each attribute information, an image feature list in which the number of image features co-occurring in the images with respect to each attribute information is less than a predetermined number;
a selection unit configured to select image features to be used as image features of a inputted query image and image features not to be used, from among the image features extracted with respect to the query image input by the input unit, based on image features included in the image feature list corresponding to attribute information about photographing of the query image obtained by an acquisition unit; and
a comparison unit configured to perform a similarity comparison between image features of the query image selected to be used as the image features of the query image and image features of registered images stored in the storage unit.

13. The image retrieval apparatus according to claim 12, wherein a size or the number of image features of the query image to be used in the comparison unit is determined in advance.

14. The image retrieval apparatus according to claim 12, wherein the attribute information about photographing includes at least one of a location, a photographing azimuth direction, time, a weather condition, a photographing mode, and an object attribute.

15. The image retrieval apparatus according to claim 12, wherein the generation unit is configured to describe, in the image feature list, image features stored in the storage unit and having a co-occurrence value smaller than a threshold with respect to registered images matching at least one piece of the attribute information, or a predetermined number of image features in ascending order of the co-occurrence value.

16. The image retrieval apparatus according to claim 12, wherein the generation unit is configured to describe, in the image feature list, image features in which a co-occurrence value of the images stored in association with image features with respect to registered images matching at least one piece of the attribute information is smaller than a threshold, or the number of image features is determined in an ascending order of the co-occurrence value.

17. The image retrieval apparatus according to claim 12, wherein the generation unit is configured to describe a user-selected image features in the image feature list, based on a co-occurrence value of images stored in association with the image features with respect to registered images matching at least one piece of the attribute information.

18. The image retrieval apparatus according to claim 12, wherein the generation unit is configured to generate with respect to each of the compass direction in a photographing location of the images, an image feature list in which the number of image features co-occurring in the images with respect to each of the compass direction is less than a predetermined number.

19. The image retrieval apparatus according to claim 12, wherein the selection unit is configured to select the image features by extracting image features matching the image features included in the image feature list from the image features of the query image.

20. The image retrieval apparatus according to claim 12, wherein the selection unit is configured to select the image features by deleting image features not existing in the image feature list from the image features of the query image.

21. The image retrieval apparatus according to claim 1, wherein the selection unit is configured to select the image features by identifying image features matching the image feature list in the image features of the query image.

22. An image retrieval apparatus comprising:
a storage unit configured to store image features corresponding to an image and attribute information about photographing;
a generation unit configured to generate with respect to each of attribute information, the image feature list in which the number of image features co-occurring in the image with respect to each of the attribute information is less than a predetermined number;
a transmission unit configured to transmit the image feature list corresponding to attribute information about photographing of a query image to a request source in response to a request;
a reception unit configured to receive image features selected by the request source as an image feature to be used as an image feature of the query image, based on image features included in the image feature list; and
a comparison unit configured to compare the received image features of the query image with the image features stored in the storage unit.

23. A query image providing apparatus comprising:
an input unit configured to input a query image;
an acquisition unit configured to obtain attribute information about photographing of the query image;
an extraction unit configured to extract image features of the query image;
a reception unit configured to receive an image feature list from an image retrieval apparatus;
a selection unit configured to select an image feature to be used as an image feature of the query image and an image feature which use is restricted, from the image features of the query image, based on image features included in the image feature list corresponding to the attribute information; and
a transmission apparatus configured to transmit image features selected to be used as the image feature of the query image to the image retrieval apparatus.

24. An image retrieval method comprising:
storing image features extracted from an input image and the image into a storage unit in association with each other;
generating a frequently appearing image feature list summarizing image features including similar image features stored in the storage unit which are greater than a predetermined number;
selecting an image feature to be used as an image feature of a query image input by an input unit, from image features extracted from the query image by an extraction unit, based on the image features included in the frequently appearing image feature list; and
comparing image features selected to be used as the image feature of the query image with image features of a registration image stored in the storage unit.

25. An image retrieval method comprising:
storing image features corresponding to an image into a storage unit;
generating a frequently appearing image feature list summarizing image features in which the number of registration of image features stored in the storage unit or the number of images stored in association with the image features in the storage unit is greater than a predetermined number;
transmitting the frequently appearing image feature list to a request source in response to a request;
receiving image features selected by the request source as an image feature to be used as an image feature of a query image, based on the image features included in the frequently appearing image feature list; and
comparing the received image features of the query image with the image features stored in the storage unit.

26. A query image providing method comprising:
inputting a query image;
extracting image features of the query image;
receiving a frequently appearing image feature list from an image retrieval apparatus;
selecting an image feature to be used as an image feature of the query image and an image feature which use is restricted, from the image features of the query image, based on image features included in the frequently appearing image feature list; and
transmitting image features selected to be used as the image feature of the query image, to the image retrieval apparatus.

27. An image retrieval method comprising:
storing image features extracted from an input image, attribute information about photographing obtained from the input image, and the image in a storage unit in association with each other;
generating with respect to each of the attribute information, an image feature list in which the number of image features co-occurring in the image with respect to each of the attribute information is less than a predetermined number;
selecting an image feature to be used as an image feature of a query image and an image feature which use is restricted, from among image features extracted from the query image by an extraction unit with respect to the query image input by an input unit, based on image features included in the image feature list corresponding to attribute information about photographing of the query image obtained by an acquisition unit; and
performing a similarly comparison between image features of the query image selected to be used as the image feature of the query image and image features of a registration image stored in the storage unit.

28. An image retrieval method comprising:
storing image features corresponding to an image and attribute information about photographing into a storage unit;
generating with respect to each of the attribute information, the image feature list in which the number of image features co-occurring in the image with respect to each of the attribute information is less than a predetermined number;
transmitting the image feature list corresponding to attribute information about photographing of a query image to a request source in response to a request;
receiving image features selected by the request source as an image feature to be used as an image feature of the query image, based on image features included in the image feature list; and
comparing the received image features of the query image with the image features stored in the storage unit.

29. A query image providing method comprising:
inputting a query image;
obtaining attribute information about photographing of the query image;
extracting image features of the query image;
receiving an image feature list from an image retrieval apparatus;
selecting an image feature to be used as an image feature of the query image and an image feature which use is restricted, from the image features of the query image, based on image features included in the image feature list corresponding to the attribute information; and
transmitting image features selected to be used as the image feature of the query image to the image retrieval apparatus.

30. A medium storing a program for causing a computer to perform the image retrieval method according to claim 24.

31. A medium storing a program for causing a computer to perform the image retrieval method according to claim 25.

32. A medium storing a program for causing a computer to perform the query image providing method according to claim 26.

33. A medium storing a program for causing a computer to perform the image retrieval method according to claim 27.

34. A medium storing a program for causing a computer to perform the image retrieval method according to claim 28.

35. A medium storing a program for causing a computer to perform the query image providing method according to claim 29.
